(19) United States
(12) Patent Application Publication
(10) Pub. No.: US 2010/0185756 A1
(43) Pub. Date: Jul. 22, 2010

(54) COMMUNICATION METHOD, COMMUNICATION SYSTEM, MOBILE NODE, SERVER AND NODE

(75) Inventors: Hong Cheng, Singapore (SG); Pek Yew Tan, Singapore (SG); Takashi Aramaki, Osaka (JP); Takako Hori, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/666,278

(22) PCT Filed: Jun. 24, 2008
(86) PCT No.: PCT/JP2008/001644

§ 371 Date: Dec. 22, 2009

(30) Foreign Application Priority Data
Jun. 26, 2007 (JP) 2007-167660
Aug. 6, 2007 (JP) 2007-204442

(51) Int. Cl. G06F 15/177

(52) U.S. Cl. 709/221

(57) ABSTRACT

A technique is disclosed of, when a mobile node has moved outside of a domain using a local address, enabling an old path of the mobile node in the domain to be torn down without using special means such as a STUN server. According to this technique, a MN 101 and a SANE 103 register a group to a group server 201 using a group registration request message 3001 and a group join request message 3007, respectively. When the MN 101 moves to a new location (MN 110) outside of a NAT domain 100, the MN 110 transmits a MN trigger message 3011 to the group server 201. Receiving the MN trigger message 3011 from the MN 110, the group server 201 transmits a group trigger message 3013 to all SANEs 103 in a group member list. Receiving the group trigger message 3013, the SANEs 103 tear down a state of an old path of the MN 101 before movement and release a resource thereof.

### TECHNICAL FIELD

The present invention relates to a communication method, a communication system and a mobile node when the mobile node crosses a border between domains using local addresses.

The present invention further relates to a node that keeps a state of a path(s) of a mobile node in a domain using a local address and gets a resource, and a server that manages the node.

### BACKGROUND ART

A communication network is normally divided into a plurality of subdomains having different address spaces. A local address for the subdomain is not valid beyond an address border. Therefore, an address border is equipped with a network address translator (NAT) for example. A local address (private address) that a node behind the NAT uses cannot be seen from nodes outside of a NAT domain. The NAT executes address mapping so as to allow nodes in the domain and nodes outside of the domain to exchange packets. The following Non-Patent Documents 1, 2, 3, 4, 5, 7, 8, and 9 disclose other conventional techniques.

Non-Patent Document 1: STUN Simple Traversal of User Datagram Protocol (UDP) Through Network Address Translators (NATs). J. Rosenberg, J. Weinberger, C. Huitema, R. Mahy, RFC3489 HYPERLINK “http://www.ietf.org/rfc/rfc3489.txt” http://www.ietf.org/rfc/rfc3489.txt

Non-Patent Document 2: Next Steps in Signaling (NSIS): Framework. R. Hancock, G. Karagiannis, J. Loughney, S. Van den Bosch. RFC4080 HYPERLINK “http://www.ietf.org/rfc/rfc4080.txt” http://www.ietf.org/rfc/rfc4080.txt

Non-Patent Document 3: Resource ReSerVation Protocol (RSVP) Version 1 Functional Specification. R. Braden, Ed. RFC2205 HYPERLINK “http://www.ietf.org/rfc/rfc2205.txt” http://www.ietf.org/rfc/rfc2205.txt

Non-Patent Document 4: Multicast Address Dynamic Client Allocation Protocol (MADCAP), S. Hanna, B. Patel, M. Shah, RFC2730 HYPERLINK “http://www.ietf.org/rfc/rfc2730.txt” http://www.ietf.org/rfc/rfc2730.txt

Non-Patent Document 5: Protocol Independent Multicast Sparse Mode (PIM-SM): Protocol Specification (Revised), B. Fenner, M. Handley, H. Holbrook, I. Kouvelas, RFC4601, HYPERLINK “http://www.ietf.org/rfc/rfc4601.txt” http://www.ietf.org/rfc/rfc4601.txt

Non-Patent Document 6: NSLP for Quality-of-Service Signaling. J. Manner, G. Karagiannis, A. McDonald. Internet-Draft draft-ietf-nsis-qos-nslp-14.txt, work in progress.

Non-Patent Document 7: Remote Authentication Dial In User Service (RADIUS): C. Rigney, A. Rubens, W. Simpson, S. Willens, RFC2138 HYPERLINK “http://www.ietf.org/rfc/rfc2138.txt” http://www.ietf.org/rfc/rfc2138.txt

Non-Patent Document 8: Diameter Base Protocol: P. Calhoun, J. Loughney, E. Guttman, G. Zorn, J. Arkko, RFC3588 HYPERLINK “http://www.ietf.org/rfc/rfc3588.txt” http://www.ietf.org/rfc/rfc3588.txt

Non-Patent Document 9: 3GPP System Architecture Evolution: Report on Technical Options and Conclusions (Release 7): 3GPP TR 23.882 V1.10.0 (2007-05) HYPERLINK “http://www.3gpp.org/ftp/Specs/html-info/23882.htm” http://www.3gpp.org/ftp/Specs/html-info/23882.htm

Meanwhile, there may be cases where a mobile node (MN) moves, thus causing a change in the connected subdomain. FIG. 7 illustrates an exemplary case, where a MN 101 is the same as a MN 110, the MN 101 is located in a NAT domain 100, and the MN 110 is the same MN when moved outside of the NAT domain 100. The MN 101 in the NAT domain 100 and a correspondent node (CN) 107 outside of the NAT domain 100 have a communication session via a link 121 in the NAT domain 100, a node (Signaling Aware Network Entity: SANE) 103, a link 123 and a NAT 105 as well as a link 125 outside of the NAT domain 100.

Herein, it is assumed that the MN 101 moves to a new location (the MN 110 in the drawing) outside of the NAT domain 100 to connect with a network 112 (links 127 and 129). A new address is then allocated to the MN 110 at this new location after movement, so that the MN 110 cannot access a node inside the NAT domain 100. For instance, even when a SANE 103 connects with the network 112 via the NAT 105, the MN 110 after movement cannot access the SANE 103. This is because a local address of the SANE 103 that the MN 101 was informed before movement cannot be used as destination for a packet from the location of the MN 110 after movement.

A signaling state and a resource allocated over the SANE 103 for the communication session of the MN 101 before movement should be released after movement to the location of the MN 110. To this end, a soft state method can be used to release the resource by making the signaling state time-out, which, however, compromises effective utilization of the resource. Therefore, a well-defined signaling is desirable to tear down the signaling state. However, there is a problem as described above that the MN 100 at the new location after movement cannot signal to the SANE 103.

As a method to cope with the above-stated problem, it can be considered that a STUN server of Non-Patent Document 1 is used so that the MN 110 after movement directly transmits a packet to the public address of the SANE 103. This resolution, however, needs to add the following requirements. Firstly, the SANE 103 needs to support the STUN protocol, and a STUN server is required under the network 112. Further, the MN 101 before movement needs to store additional public address information of the SANE 103. Moreover, when the MN 101 before movement has a plurality of sessions, i.e., a plurality of SANEs, the data amount of this new address information increases. A special protocol is further required to exchange this new address information between the MN 101 before movement and the SANE 103. Finally, a protocol such as STUN may not function with certain type of NAT. For instance, this includes a type of symmetric NAT.

### DISCLOSURE OF THE INVENTION

In view of the above-stated problems of conventional techniques, it is an object of the present invention to provide a communication method, a communication system, a mobile node, a server and a node that enable, when a mobile node has moved outside of a domain providing a local address with an address translator, to tear down the old path(s) of the mobile node in the domain without using special means such as a STUN server.

In order to fulfill the above-stated object, the present invention is composed of a communication method wherein, when a mobile node located in a domain using a local address has moved outside of the domain, the mobile node signals to a node in the domain, the communication method comprising the steps of:

a group registration step of transmitting, to a representative server, information on a group to which the mobile node and the node belong, the node establishing a state of the mobile node in the domain, to register the same to the representative server;

a step of transmitting the information on the group from the mobile node that has moved outside of the domain to the representative server to notify the representative server of the same;

a signaling step of signaling to the node belonging to the group from the representative server notified of the information on the group; and

a step of modifying the state of the mobile node established with the signaled node in the domain.

In order to fulfill the above-stated object, the present invention is composed of a communication system wherein, when a mobile node located in a domain using a local address has moved outside of the domain, the mobile node signals to a node in the domain, the communication system comprising:

group registration means that transmits, to a representative server, a group to which the mobile node and the node belong, the node establishing a path of the mobile node in the domain, to register the same to the representative server;

means that transmits information on the group from the mobile node that has moved outside of the domain to the representative server to notify the representative server of the same;

signaling means that signals to the node belonging to the group from the representative server notified of the information on the group; and

means that modifies the state of the mobile node established with the signaled node in the domain.

In order to fulfill the above-stated object, the present invention is composed of a mobile node in a communication system wherein, when the mobile node located in a domain using a local address has moved outside of the domain, the mobile node signals to a node in the domain, the mobile node comprising:

group registration means that transmits, to a representative server, information on a group to which the mobile node and the node belong, the node establishing a state of the mobile node in the domain, to register the same to the representative server; and

means that, when the mobile node has moved outside of the domain, transmits, to the representative server, information on the group to modify the state of the mobile node established in the domain to notify the representative server of the same.

in order to fulfill the above-stated object, the present invention is composed of a representative server in a communication system wherein, when a mobile node located in a domain using a local address has moved outside of the domain, the mobile node signals to a node in the domain, the representative server comprising:

group registration means that, when information on a group to which the mobile node and the node establishing a state of the mobile node in the domain belong is transmitted to the representative server, registers the information on the group; and

signaling means that, when the mobile node that has moved outside of the domain transmits the information on the group to the representative server to notify the representative server of the same, transmits signaling to the node belonging to the group so that the state of the mobile node established in the domain is modified.

In order to fulfill the above-stated object, the present invention is composed of a node in a communication system wherein, when a mobile node located in a domain using a local address has moved outside of the domain, the mobile node signals to the node in the domain, the node comprising:

group registration means that transmits, to a representative server, information on a group to which the mobile node and the node belong, the node establishing a state of the mobile node in the domain, to register the same to the representative server; and

means that, when the mobile node that has moved outside of the domain transmits the information on the group to the representative server and when the representative server notified of the information on the group signals the node belonging to the group, modifies the state of the mobile node established in the domain.

The above-stated information on the group may be a multicast address of the mobile node and the node, and the signaling may be from the representative server to the multicast address.

Further, the node in the domain may be notified, from the mobile node, of the information on the group using a resource reservation message including the information on the group, and the representative server may be notified, from the node notified of the information on the group, of joining to the group using a group join message including the information on the group.

Further, a first representative node and a second representative node may register the information on the group to the representative server, the first representative node being one of a plurality of nodes establishing a path of the mobile node in the domain and the second representative node being one of a plurality of nodes establishing a path of the mobile node outside of the domain, signaling may be from the representative server only to the first and the second representative nodes, and each of the first and the second representative nodes may signal to other nodes that has established a state of the mobile node in the domain and outside of the domain to modify the state of the mobile node.

With this configuration, when a mobile node is located in a domain using a local address, nodes in the domain keep a path of the mobile node and a resource, and when the mobile node has moved outside of the domain, the nodes in the domain are signaled, thus allowing the signaled nodes to tear down an old path of the mobile node in the domain.

The present invention, when a mobile node has moved outside of a domain using a local address by an address translator, enables an old path of the mobile node in the domain to be modified without using special means such as a STUN server.

### BRIEF DESCRIPTION OF THE DRAWINGS

FIG. 1 is a block diagram illustrating Embodiment 1 of a communication system according to the present invention.

FIG. 2 describes an operational sequence of the communication system of FIG. 1.

FIG. 3 is a block diagram illustrating a mobile node of FIG. 1 in detail.

FIG. 4 is a block diagram illustrating a SANE of FIG. 1 in detail.

FIG. 5 is a block diagram illustrating a group server of FIG. 1 in detail.

FIG. 6 is a block diagram illustrating Embodiment 3 of a communication system according to the present invention.

FIG. 7 is a block diagram illustrating the conventional communication system.

FIG. 8 describes a format of a group registration (Group_Register) request message of FIG. 2.

FIG. 9 describes a format of a group registration confirmation (Group_Confirm) message of FIG. 2.

FIG. 10 describes a format of group information [Group Info] of FIGS. 8 and 9 in detail.

FIG. 11 describes a format of a MN trigger (MN_Trigger) message of FIG. 2.

FIG. 12 describes a format of a group join (Group_Join) request message of FIG. 2.

FIG. 13 describes a format of a group join response (Group_Reponse) message of FIG. 2.

FIG. 14 describes a format of a group trigger (Group_Trigger) message of FIG. 2.

FIG. 15 describes a format of data entry (Srv_Group).

FIG. 16 describes a format of member list [Member List] of FIG. 15 in detail.

FIG. 17 is a block diagram illustrating a network configuration of Embodiments 6, 7, 8 and 9.

FIG. 18 describes an operational sequence of Embodiment 6.

FIG. 19 describes a format of a group join (Group_Join) request message of FIG. 18.

FIG. 20 describes a format of a group trigger (Group_Trigger) message of FIG. 18.

FIG. 21 describes an operational sequence of Embodiment 7,

FIG. 22 describes a format of a NAT notification (NAT_Notify) message of FIG. 21.

FIG. 23 describes an operational sequence of Embodiment 8.

FIG. 24 describes an operational sequence of Embodiment 9.

FIG. 25 describes a format of a group join (Group_Join) request message of FIG. 24.

FIG. 26 is a block diagram illustrating a network configuration of Embodiment 10.

### BEST MODES FOR CARRYING OUT THE INVENTION

The following describes embodiments of the present invention, with reference to the drawings.

### Embodiment 1

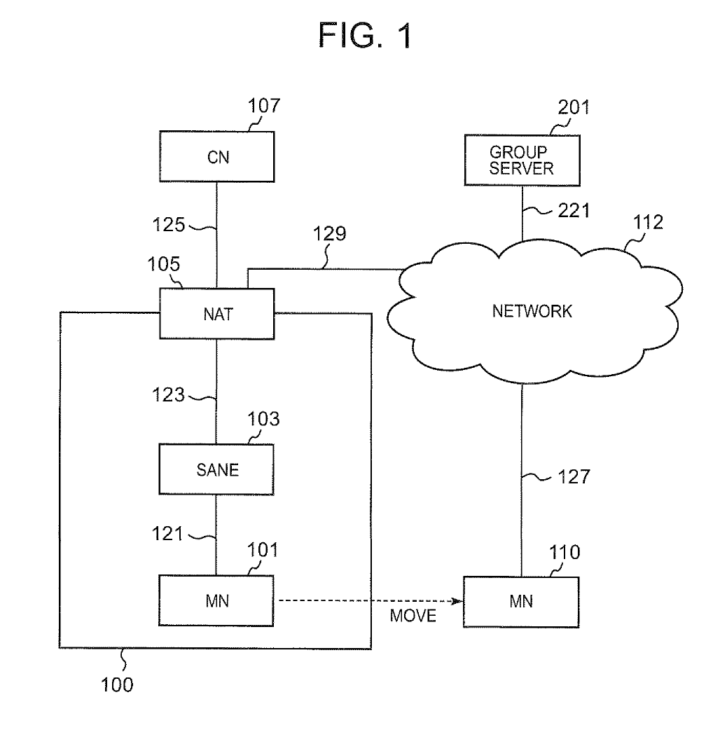

FIG. 1 is a block diagram illustrating Embodiment 1 of a communication system according to the present invention. In FIG. 1, a MN 101 in a NAT (Network Address Translator) domain 100 and a Correspondent Node (CN) 107 outside of the NAT domain 100 have a communication session via a link 121 in the NAT domain 100, a node (Signaling Aware Network Entity: SANE) 103, a link 123 and a NAT (NAT server) 105 as well as a link 125 outside of the NAT domain 100, thus forming a communication path (or paths). The SANE 103 may be a NSIS (Next Steps In Signaling) entity in Non-Patent Document 2 or a router supporting RSVP (Resource ReSerVation Protocol) in Non-Patent Document 3, for example. It would be obvious for those skilled in the art that the SANE 103 may be a node supporting other signaling applications relating to the communication session. The MN 101 and the CN 107 may be configured to have a function of the SANE 103 as well. Although this drawing illustrates a limited number of nodes due to the lack of space, it would be obvious for those skilled in the art that there may be more nodes, e.g., a plurality of SANEs existing on the path(s) inside and outside the NAT 105.

Seen from the CN 107, the MN 101 and the SANE 103 are located behind the NAT 105 and in the NAT domain 100, to which local addresses (private address) (Addr_MN_NAT) and (Addr_SANE_NAT) in the NAT domain 100 are allocated, respectively. The MN 101 uses the local address (Addr_MN_NAT) thereof as a source address of a packet to the CN 107. Herein, the NAT 105 maps the local address (Addr_MN_NAT) of the MN 101 to a public address (Addr_MN_Pub) that can be routed outside of the NAT domain 100.

Accordingly, the NAT 105 replaces the source address of a packet from the MN 101 to the CN 107 with the public address (Addr_MN_Pub). Receiving this packet, the CN 107 sets the public address (Addr_MN_Pub) as the address of the MN 101. Therefore, the CN 107 uses this public address (Addr_MN_Pub) as a destination address of a packet to the MN 101. When this packet to the MN 101 arrives at the NAT 105 from the CN 107, reverse mapping is conducted so that the packet can arrive at the MN 101 in the NAT domain 100 so as to convert the public address (Addr_MN_Pub) into the local addresses (Addr_MN_NAT). Note here that the NAT 105 may use other ways for address mapping without departing from the scope of the present invention.

Establishment of a communication path between the MN 101 and the CN 107 requires network control signaling to provide necessary support for a communication session therefor. Exemplary signaling includes Quality of Service (QoS) signaling as shown in Patent Document 2 or RSVP signaling as shown in Patent Document 3. It would be obvious for those skilled in the art that other signaling may be applied without departing from the scope of the present invention. Such signaling allows a signaling state to be created over the SANE 103 and a network resource to be allocated to a corresponding communication session.

Assuming that the MN 101 moves to a new location (MN 110) outside of the NAT domain 100 at a certain time to connect with the network 112 via a link 127, a new address (Addr_MN_Nw) is allocated to the MN 110 at this new location. Since the network 112 has address spaces different from those in the NAT domain 100, the MN 110 can no longer directly address the SANE 103 using the local address (Addr_SANE_NAT). It would be obvious for those skilled in the art that the network 112 of a configuration different from the present embodiment may not influence the present invention. For instance, the network 112 that is another NAT domain different form the NAT domain 100 can be applied similarly.

In FIG. 1, a group server 201 is provided for the network 112. The group server 201 can be addressed globally, so that the MN 101 before movement, the SANE 103, and the MN 110 at the new location after movement can communicate with the group server 201 using a certain address or identifier. This can be implemented by allocating a global (public) IP address or a FQDN (Fully Qualified Domain Name) to the group server 201. Although in FIG. 1 the group server 201 connects with the network 112 outside of the NAT domain 100, another connection configuration also is available. For instance, the group server 201 may be disposed in the NAT domain 100 where the NAT 105, the SANE 103, and the MN 101 before movement are located. This configuration does not influence the present invention. Further, the group server 201 may be configured using a distributed type server group. Exemplary group servers include an AAA server (a RADIUS server of Non-Patent Document 7 and a DIAMETER server of Non-Patent Document 8), PCRF (Policy and Charging Rules Function) of Non-Patent Document 9, and a multicast server described later.

<Operational Sequence>

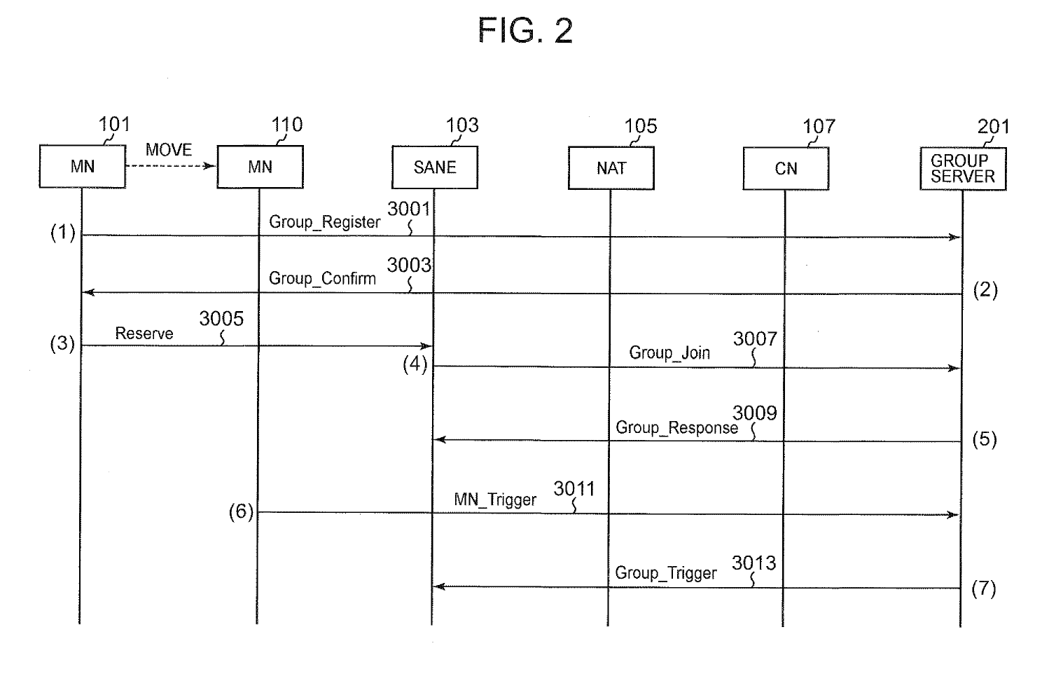

FIG. 2 illustrates an exemplary operational sequence of the present invention.

(1) Firstly, when the MN 101 before movement starts a communication session with the CN 107, the MN 101 registers a group (group A) to the group server 201. This registration can be conducted with a group registration (Group_Register) request message 3001 transmitted to the group server 201, and the group registration request message 3001 is transmitted to a global address of the group server 201. The MN 101 can obtain the global address (public address) of the group server 201 in various ways. For example, the MN 101 may have the global address of the group server 201 in advance, may inquire it from a local DNS (Domain Name System) server, or may be informed of proxy of the group server 201 in advance and transmit a message thereto. It would be obvious for those skilled in the art that the MN 101 can obtain the global address of the group server 201 in other ways without departing from the scope of the present invention.

(2) Receiving the group registration request message 3001 from the MN 101, the group server 201 authenticates this request message. If the authentication succeeds, the group server 201 creates a necessary information entry for this MN. This information entry may include, for example, an ID of the MN 101, a group ID, security association (SA), a member list of the group, and the like. As an option, if this protocol requires, the group server 201 confirms, from the MN 101, a processing result using a group registration confirmation (Group_Confirm) message 3003. The group registration confirmation message 3003 may include information showing whether the group registration is OK or not and additional information to use the loop, e.g., security association information.

(3) When the MN 101 has registered the group A to the group server 201, the MN 101 embeds association information in a signaling message to the SANE 103. For instance, the MN 101 can include “group information elements” providing an address of the group server 201, information on the group A, security association information, and the like to a resource reservation (Reserve) message 3005 to the SANE 103.

(4) Receiving a signaling message, e.g., the reservation message 3005, from the MN 101, the SANE 103 obtains the “group information elements” from the message 3005, and joins in a group relating to a session signaled using the “group information elements”. This joining can be implemented by transmitting a group join (Group join) request message 3007 to the group server 201. The group join request message 3007 is transmitted to a server address indicated by the “group information elements” in the received reservation message 3005. The SANE 103 includes information necessary to group operations, e.g., information on the group A, security association information and the like to the group join request message 3007. It would be obvious for those skilled in the art that a destination of the group join request message 3007 is not always to the group server 201 directly from the SANE 103, but may be via several intermediate means, e.g., proxy.

(5) Receiving the group join request message 3007, the group server 201 verifies the message 3007 to check the existence of the group A and verity the security association information attached thereto. If the verification is OK, the group server 201 sets the SANE 103 in the member list of the group A. This can be implemented also by copying the source address of the group join request message 3007 to the member list of the group A or by, if a special SANE-ID exists in the group join request message 3007, fetching the SANE-ID, for example. Next, as an option, the group server 201 transmits a group join response (Group Response) message 3009 to the SANE 103 to inform the same of a result of the group join request.

(6) Next, in the case where the MN 101 moves to a new location (MN 110) outside of the NAT domain 100, the MN 100 does not send directly to the SANE 103, but transmits a MN trigger (MN_Trigger) message 3011 to the group server 201. The MN 110 executes this processing by detecting that its new location belongs to a domain of a different address by a different domain name or a new address prefix, for example. The MN trigger message 3011 includes an identifier of the group A, necessary security association information, signaling message contents transmitted to the SANE 103, and the like. For instance, in the case where the SANE 103 supports NSIS QoS signaling application, this signaling message may include a “tear flag” set in a reserve message described in Non-Patent Document 6.

(7) Receiving the MN trigger message 3011 from the MN 110, the group server 201 verifies the MN trigger message 3011 using the security association information attached in the message 3011. If the verification is OK, the group server 201 transmits signaling message contents of the MN trigger message 3011 to all members (nodes) in the member list relating to the group A. This can be implemented by transmitting a group trigger (Group_Trigger) message 3013 to all SANEs 103 in the member list. The SANE 103 collects the signaling message contents (MN trigger message 3011) in the group trigger message 3013 and executes operations defined by signaling application rules. For instance, the SANE 103 tears down a state of the old path(s) of the MN 101 established before movement, and executes processing to release a resource thereof.

It would be obvious for those skilled in the art that still more nodes can be included without departing from the scope of the present invention. For instance, in the case where a plurality of SANEs exist in the network, the MN 101 before movement may transmit a reservation message 3005 to all of the SANEs, and all of the SANEs may transmit a group join request message 3007 to the group server 201. Further, receiving these group join request messages 3007, the group server 201 may transmit a group trigger message 3013 to the plurality of SANEs.

It would be obvious for those skilled in the art that the steps for the above-stated (1) for the group registration request message 3001 and (2) for the group registration confirmation message 3003 may be conducted only once per location where the MN 101 stays. For instance, in the case where the same MN 101 conducts a communication using a plurality of sessions passing along different paths, SANEs existing on the plurality of paths may join in the same group. This is rational because the MN 101 can transmit the same tear trigger to all of the SANEs for the location before movement. As an option, when the MN 101 detects a change in the location, the group registration request message 3001 may be transmitted in the new location for example after the MN trigger message 3011.

<Configuration of MN 101>

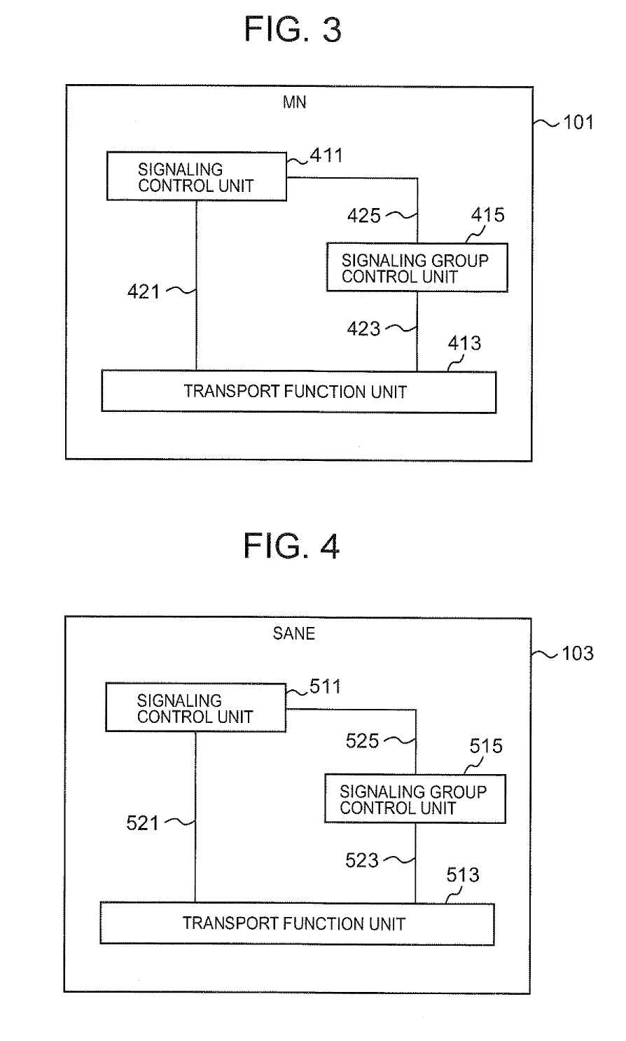

The configuration of the MN 101 will be described with reference to FIG. 3. Note that FIG. 3 illustrates only the configuration to implement functions of the MN 101 of the present invention. The MN 101 roughly includes three elements of a signaling control unit 411, a transport function unit 413, and a signaling group control unit 415. The signaling control unit 411 executes functions required for a signaling application such as NSIS (Next Steps In Signaling) in Non-Patent Document 2 or RSVP (Resource ReSerVation Protocol) in Non-Patent Document 3, for example. The signaling group control unit 415 executes the above-described group management between the MN 101 and the group server 201. The transport function unit 413 transmits a message created by the signaling control unit 411 and the signaling group control unit 415. The transport function unit 413 may simply execute IP, TCP (Transmission Control Protocol) and/or UDP (User Datagram Protocol), for example.

An interface 421 connects the signaling control unit 411 and the transport function unit 413, and executes functions required for signaling application such as NSIS, for example. An interface 423 connects the signaling group control unit 415 and the transport function unit 413, and executes a function to support message exchange between the MN 101 and the group server 201. As illustrated in FIGS. 2 (1), (6), and (3), the interface 423 for example supports transmission of the group registration request message 3001 and the MN trigger message 3011 from the MN 11 and reception of the group registration confirmation message 3003 from the group server 201. This may be a simple UDP socket, and if a more complicated protocol is required between the MN 101 and the group server 201, the interface 423 may execute a function required therefor.

An interface 425 that connects the signaling control unit 411 and the signaling group control unit 415 provides “MG creation” (MG_Create), “MG confirmation” (MG_Confirm) and “MG trigger” (MG_Trigger) as major functions. “MG creation” and “MG trigger” are directed from the signaling control unit 411 to the signaling group control unit 415, and “MG confirmation” is directed from the signaling group control unit 415 to the signaling control unit 411.

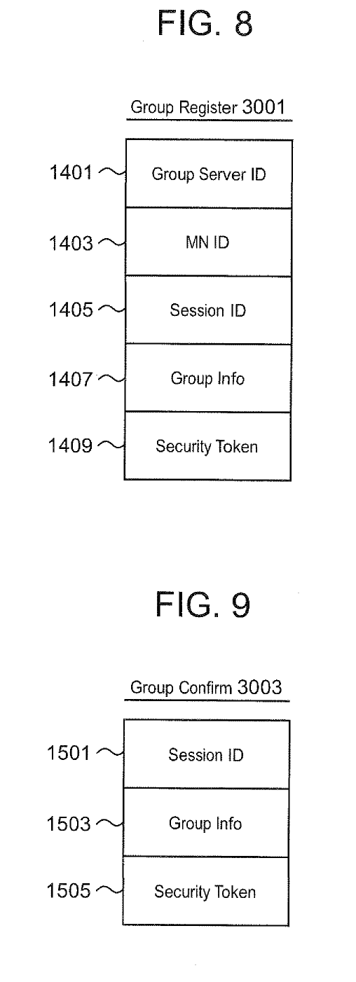

Herein, in the situation where there is a need for the signaling control unit 411 to start a signaling session, this situation is referred to as “MG creation”, where the group is required to be allocated to the session. The signaling group control unit 415 checks whether the signaling group control unit 415 itself registers an effective group therein while setting the function of the “MG creation” as a trigger. If it does not register the group information, the signaling group control unit 415 creates the group registration request message 3001, and passes the same to the transport function unit 413 via the interface 423. A format of the group registration (Group_Register) request message 3001 may be configured as in FIG. 8 and as follows, for example,

Group_Register:
group server ID 1401 [Group Server ID]
MN-ID 1403 [MN ID]
session ID 1405 [Session ID]
group information 1407 [Group Info]
security token 1409 [Security Token].

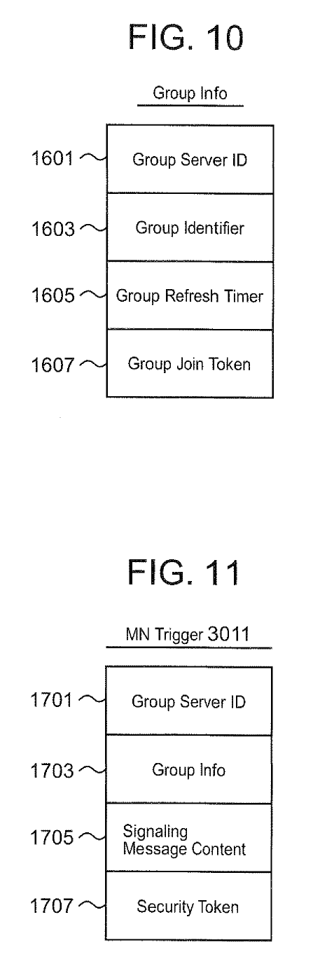

The group server ID 1401 is an identifier globally unique for the group server 201, which may be a FQDN (Fully Qualified Domain Name), for example. The MN 101 can obtain this group server ID 1401 in advance, or can acquire by a local configuration, e.g., DHCP (Dynamic Host Configuration Protocol). The MN-ID 1403 is an identifier of the MN 101 that transmits in the group registration request message 3001, which may be a local IP address of the MN 101, for example, i.e., user's address information. The group information 1407 includes group allocation information that the MN 101 wishes. For example, the group information 1407 [Group Info] may include the following information as illustrated in FIG. 10,

Group Info:
group server ID 1601 [Group Server ID]
group identifier 1603 [Group Identifier]
group refresh timer 1605 [Group Refresh Timer]
Group join Coke 1607 [Group Join Token].

Herein, when the MN 101 requests the group server 201 to conduct group allocation, the group information 1407 can be omitted. The security token 1409 may be included as an option if the group server 201 requires authentication of the MN 101.

Referring back to FIG. 3, the transport function unit 413 resolve the group server ID via DNS query, for example, to determine an actual transmission method of the group registration request message 3001, for instance, to determine whether the message is to be transmitted directly to an IP address of the group server 201 or to be transmitted via proxy. If the group registration request message 3001 successfully arrives at the group server 201, the MN 101 will receive the group registration confirmation message 3003. Receiving this group registration confirmation message 3003, the transport function unit 413 passes the same to the signaling group control unit 415 via the interface 423. The group registration confirmation (Group_Confirm) message 3003 may be configured as in FIG. 9 and as follows, for example,

Group_Confirm:
session ID 1501 [Session ID]
group information 1503 [Group Info]
security token 1505 [Security Token].

The session ID 1501 has the same configuration as that of the group registration request message 3001. However, in the case where the group desired by the MN 101 as indicated in group registration request message 3001 cannot be provided, the group server 201 makes the group information 1503 include different group allocation. The group information 1503 includes information on a group allocated by the group server 201.

Similarly to the group registration request message 3001, a group server ID 1601 of the group registration confirmation message 3003 is an identifier of the group server 201 that provides a service to the allocated group. Note here that when proxy or server balancing is used, the group server ID 1601 may be one different from that of the group server 201 to which the group registration request message 3001 is transmitted. The group identifier 1603 is information relating to a group used for signaling session, and a format thereof may be selected by the group server 201. The group refresh timer 1605 is a time limit for the group server 201 to provide a service to a group thereof. Herein, the MN 101 needs to update the group refresh timer 1605 for the group server 201. This updating can be implemented by resending the group registration request message 3001 to the group server 201 before the completion of the group refresh timer 1605. The group join token 1607 provides a code for verification that is helpful for the group server 201 to authenticate the group in which the SANE 103 joins.

The signaling group control unit 415 keeps the group information 1503 and the security token 1505 to call a function of “MG confirmation” and passes the group information 1503 to the signaling control unit 411 that receives “MG confirmation”. The signaling control unit 411 embeds the group information 1503 in the reservation message 3005 and sends the same to the signaling session.

When the MN 101 detects the movement, the signaling control unit 411 decides to tear down a signaling state established before the movement, and the signaling control unit 411 is further required to signal to the SANE 103 on the path(s) before the movement. Then, the signaling control unit 411 calls a function of “MG trigger” and passes the reservation message 3005 with a tear flag to the signaling group control unit 415. The signaling group control unit 415 creates a MN trigger message 3011 and embeds the reservation message 3005 in the MN trigger message 3011. This MN trigger message 3011 is passed to the transport function unit 413, which is then transmitted to the group server 201. An exemplary configuration of the MN trigger (MN_Trigger) message 3011 is illustrated in FIG. 11 and in the following,

MN_Trigger:
group server ID 1701 [Group Server ID]
group information 1703 [Group Info]
signaling message contents 1705 [Signaling Message Content]
security token 1707 [Security Token].

The group server ID 1701 and the group information 1703 can be obtained from the group information 1503 in the group registration confirmation message 3003. The signaling message contents 1705 is a signaling message passed to the SANE 103, which may be a reservation message 3005 with a tear flag, for example. The security token 1707 can be obtained from the last group registration confirmation message 3003.

<Configuration of SANE 103>

Referring now to FIG. 4, the configuration of the SANE 103 will be described below. Note that FIG. 4 illustrates only the configuration to implement functions of the SANE 103 of the present invention. The SANE 103 roughly includes three elements of a signaling control unit 511, a transport function unit 513, and a signaling group control unit 515. The signaling control unit 511 and the transport function unit 513 have functions similar to those of the signaling control unit 411 and the transport function unit 413 of the MN 101. However, the signaling control unit 411 operates as a signaling initiator (SI), whereas the signaling control unit 511 operates as a signaling transfer unit or a signaling responder (SR).

An interface 525 between the signaling control unit 511 and the signaling group control unit 515 executes three functions of SG join (SG_Join), SG confirmation (SG_Confirm), and SG notification (SG_Notify). “SG join” is conducted from the signaling control unit 511 to the signaling group control unit 515, and “SG confirmation” and “SG notification” are conducted from the signaling group control unit 515 to the signaling control unit 511. Note here that “SG confirmation” is an option.

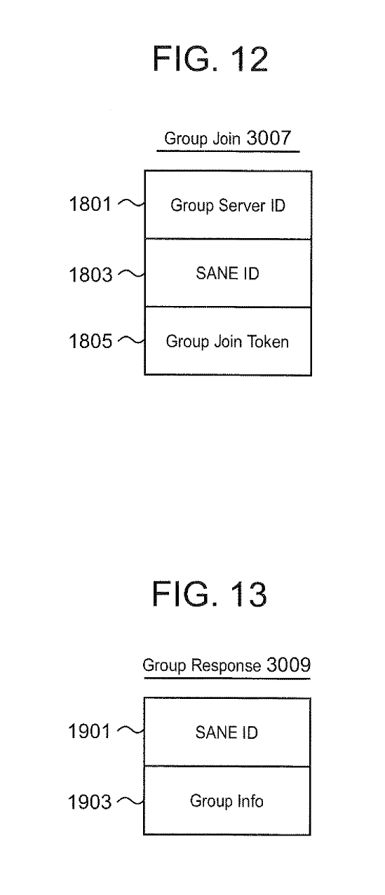

Receiving a reservation message 3005, for example, from the MN 101, the signaling control unit 511 executes processing defined by signaling application, and further checks whether the reservation message 3005 includes “group information” or not. If “group information” is included, the signaling control unit 511 calls a function of “SG join” and passes “group information” to the signaling group control unit 515. Based on “group information”, the signaling group control unit 515 creates a group join request message 3007, which is passed to the transport function unit 513 and transmitted to the group server 201. The group join (Group Join) request message 3007 may be configured as in FIG. 12 and as follows,

Group_Join:
group server ID 1801 [Group Server ID]
SANE-ID 1803 [SANE ID]
group join token 1805 [Group Join Token].

The group server ID 1801 and the group join token 1805 are obtained from “group information”. The SANE-ID 1803 is an option. For instance, if the SANE 103 is informed a public address thereof after mapping by the NAT 105, the SANE 103 may insert the public address in the SANE-ID 1803.

When the group server 201 returns a group join response message 3009 as an optional response to the SANE 103, the transport function unit 513 passes the group join response message 3009 to the signaling group control unit 515. The group join response (Group Response) message 3009 may be configured as in FIG. 13 and as follows, for example,

Group Response:
SANE-ID 1901 [SANE ID]
group information 1903 [Group Info].

The SANE-ID 1901 is inserted by the group server 201 that copies the SANE-ID 1801 in the group join request message 3007 or a source address of the group join request message 3007. The group information 1903 is copied from the message 3001. The group information 1903 also is an option that can be used by the group server 201 to adjust the group refresh timer 1605, for example.

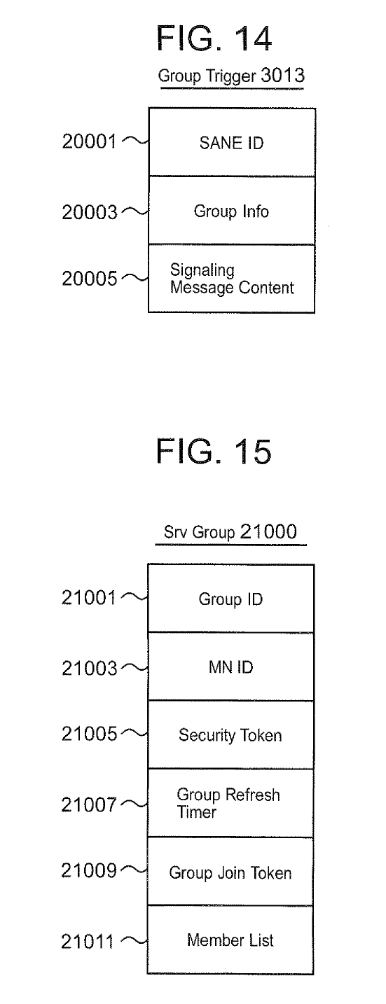

Receiving the MN trigger message 3011, the group server 201 transmits the group trigger message 3013 to the SANE 103. A format of the group trigger message 3013 is configured as in FIG. 14 and as follows, for example,

Group_Trigger:
SANE-ID 20001 [SANE ID]
group information 20003 [Group Info]
signaling message contents 20005 [Signaling Message Content].

The SANE-ID 20001 is an address of the SANE 103 registered in the group server 201, and the group information 20003 and the signaling message contents 20005 can be obtained from the MN trigger message 3011.

Receiving the group trigger message 3013, the signaling group control unit 515 calls a function of “SG notification” to pass the signaling message contents 20005 to the signaling control unit 511, which is then led to an operation to remove a state of the old path(s) of the MN 101 (or modify the state to invalid), release a resource, or the like.

<Configuration of Group Server 201>

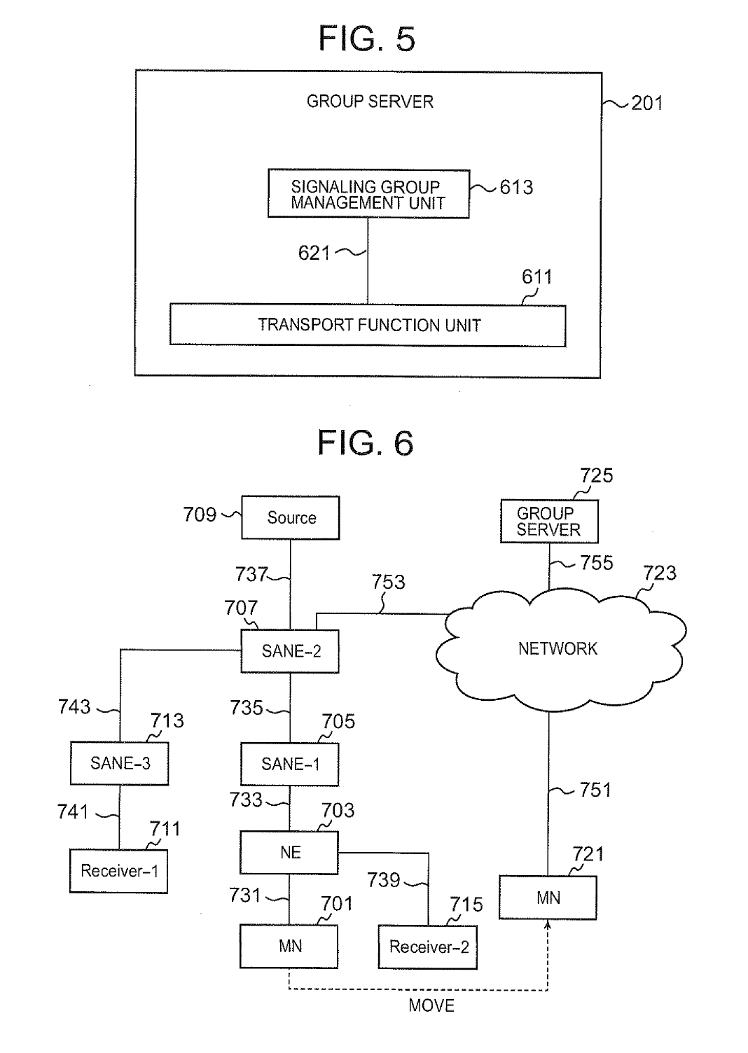

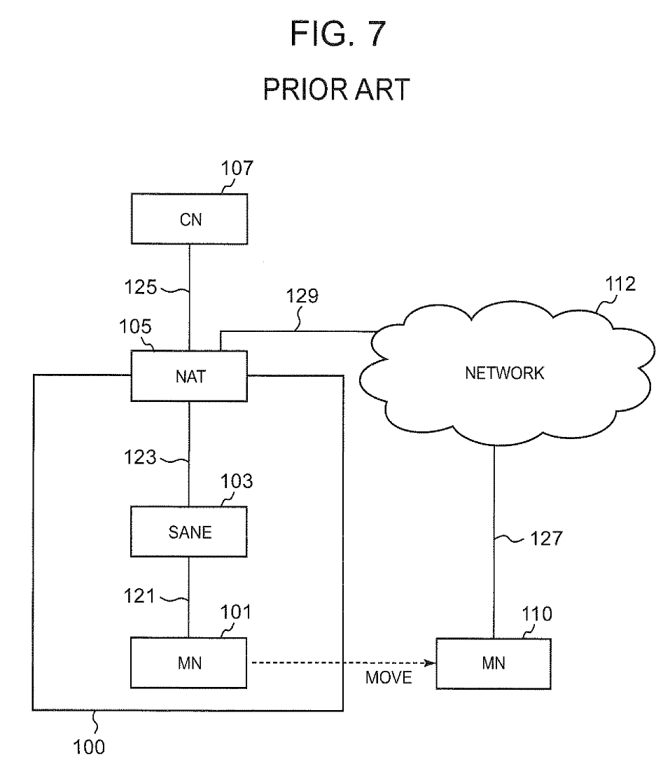

Referring now to FIG. 5, the configuration of the group server 201 will be described below. Note that FIG. 5 illustrates only the configuration to implement functions of the group server 201 of the present invention. The group server 201 roughly includes two elements of a signaling group management unit 613 and a transport function unit 611, and an interface 621 connects the signaling group management unit 613 and the transport function unit 611. Receiving the group registration request message 3001, the group join request message 3007 and the MN trigger message 3011, the transport function unit 611 passes them to the signaling group management unit 613.

Obtaining the group registration request message 3001, the signaling group management unit 613 creates a group of the MN 101, and if the message 3001 does not include group information 1407, the signaling group management unit 613 creates a data entry 21000 (Srv_Group) in a local information base. A format of the data entry 21000 (Srv_Group) is configured as in FIG. 15 or as follows, for example,

Srv_Group:
group ID 21001 [Group ID]
MN-ID 21003 [MN ID]
security token 21005 [Security Token]
group refresh timer 21007 [Group Refresh Timer]
group join token 21009 [Group Join Token]
member list 21011 [Member List].

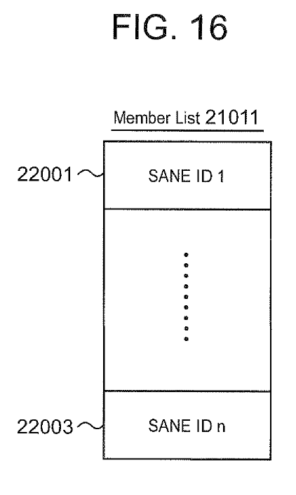

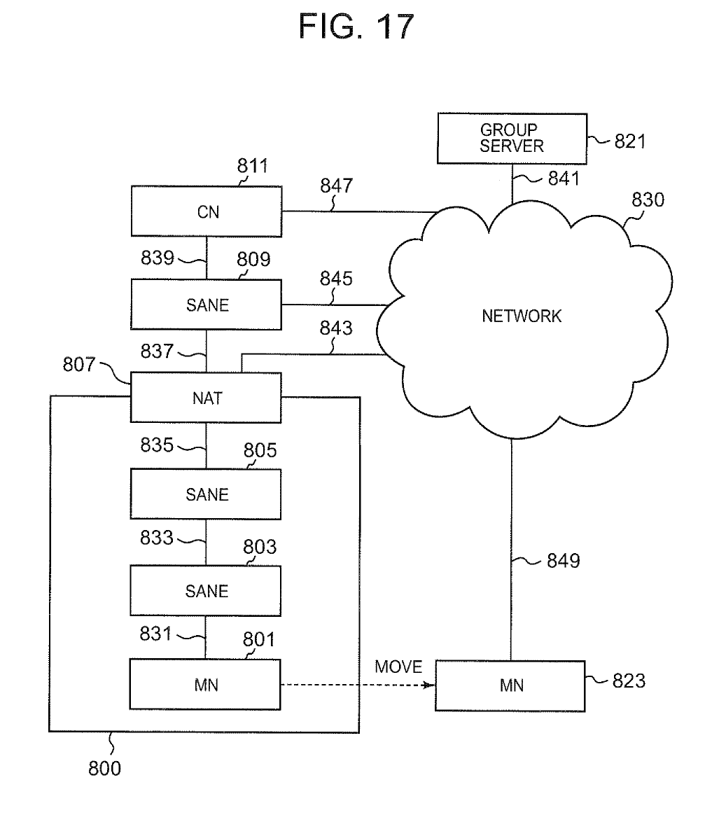

As illustrated in FIG. 16, the member list 21011 includes a plurality of SANE-IDs 22001 to 22003 (SANE-ID1 to SANE-IDn).

Thereafter, the signaling group management unit 613 creates a group registration confirmation message 3003, passes the same to the transport function unit 611, and transmits the same to the MN 101. When the message 3001 includes group information 1407, the signaling group management unit 613 refreshes the data entry 21000 (Srv_group) if the verification of the security token 1409 in the message 3001 is OK.

Obtaining the group join request message 3007, the signaling group management unit 613 checks whether the message 3007 includes the SANE-ID 1803 or not. If the SANE-ID 1803 is included, the signaling group management unit 613 adds the SANE-ID 1803 to the member list 21011 of the corresponding data entry 21000 (Srv_Group). If the SANE-ID 1803 is not included, the signaling group management unit 613 includes a source address of the message 3007 to the member list 21011. Thereafter, the signaling group management unit 613 creates a group join response message 3009, passes the same to the transport function unit 611, and transmits the same to the SANE 103.

Obtaining the MN trigger message 3011, the signaling group management unit 613 fetches the group information 1703 from the message 3011. The signaling group management unit 613 further disposes the data entry 21000 (Srv_Group) in the same group ID 21001 and the MN-ID 21003, and subsequently fetches the member list 21011. If the member list 21011 is included, the signaling group management unit 613 creates a group trigger (Group_Trigger) message 3013, and transmits the same to all of SANE-IDs 22001 to 22003 in the member list 21011. Thereafter the signaling group management unit 613 may delete the data entry 21000 (Srv_Group) based on a local policy in the MN trigger message 3011 or an instruction.

It would be obvious for those skilled in the art that the MN 101 can execute functions of the SANE 103 and/or the group server 201. It would be further obvious for those skilled in the art that the group join request message 3007 can be used to let the SANE 103 out from the group. In this case, information on the SANE 103 can be removed from the recording of the group server 201 by setting a value at which the SANE 103 becomes an error as the group join token 1805 in the group join request message 3007.

### Embodiment 2

Embodiment 1 describes the group server 201. It would be, however, obvious for those skilled in the art that the present invention is applicable to a distributed virtual type group server as well. Embodiment 2 can be implemented by using a multicast method. In Embodiment 2, an IP multicast group address, instead of a group, is allocated to the MN 101. The MN 101 obtains the right to use this address from Out Of Band Methods. For instance, the MN 101 uses MADCAP (Multicast Address Dynamic Client Allocation Protocol) shown in Non-Patent Document 4 to request a multicast address from a server. A reservation message 3005 that the MN 101 transmits has two information elements of an IP multicast group address and RP (Rendezvous Point) shown in Non-Patent Document 5. The IP multicast group address in the present embodiment is equivalent to a “group ID” in Embodiment 1, and RP is equivalent to the “group server ID”.

Receiving the reservation message 3005, the SANE 103 transmits a PIM (Protocol Independent Multicast) join message to the RP to join in the IP multicast group address. The PIM join message contains information similar to that of the group join request message 3007 in Embodiment/, allowing to configure a multicast distribution tree. Thus, a member list of the SANE is not kept by a central server, but is kept on all routers that support multicast for the RP as a part of tree information.

Therefore, the MN 110, which arrives at a new location, transmits the MN trigger message 3011 to the RP. The RP converts the MN trigger message 3011 into a format of the group trigger message 3013, and transmits the same to the IP multicast group address. The group trigger message 3013 is transferred along the multicast tree, thus arriving at the SANE 103 as a result.

### Embodiment 3

The present invention further can be used to support signaling of multicast user plane. FIG. 6 illustrates an exemplary network configuration of Embodiment 3, where MNs 701 and 721 are the same, showing before movement and after movement, respectively. In FIG. 6, a sender node 709 transmits IP traffic to a multicast group (M_G). In the multicast group (M_G), three reception-side nodes exist, including reception-side nodes 711 (Receiver-1) and 715 (Receiver-2), and the MN 701 before movement. The reception-side node 711 connects with the sender node (Source) 709 via SANEs 713 (SANE-3) and 707 (SANE-2), the reception-side node 715 connects with the sender node 709 via a network entity (NE) 703, SANEs 705 (SANE-1) and 707, and the MN 701 before movement connects with the sender node 709 via the NE 703 and the SANEs 705 and 707.

RSVP of Non-Patent Document 3 enables signaling for QoS to be conducted from each of the three reception-side nodes 711, 715, and 701 to the sender node 709. Herein, let that the reception side node 711 requests QoS level Q1, the QoS level Q1 is higher than QoS level Q2 requested by the MN 701, and the SANEs 713 and 707 install a QoS reservation state of the QoS level Q1. When a QoS reservation message of the QoS level Q2 from the MN 701 arrives at the SANE 707, the QoS reservation message of the QoS level Q2 from the MN 701 is ignored because a QoS reservation state higher than that exists at the SANE 707. Similarly, if QoS request level Q3 of the reception side node 715 is lower than the QoS level Q2, the QoS state at the SANE 705 is only the QoS level Q2.

Thus, the configuration described in Embodiment 1 is applicable to this connection example as well. The reservation message 3005 having “group information” is processed only by the SANE 705. In this case, the SANE 705 only transmits the group join request message 3007 to a group server 725. When the MN 701 moves to a new location so as to connect with a network 723 (MN 721 of the drawing), a QoS reservation state on the old path(s) at the SANE 705 should be torn down (i.e. be changed or modified the state is no longer available or valid). In Embodiment 1, the MN trigger message 3011 transmitted to the group server 725 is converted into the group trigger message 3013, and is transmitted to the SANE 705 registered in the group server 725. This is a desirable operation.

In this case, the multicast reservation state in Embodiment 3 changes. For instance, the reception-side node 711 starts reservation signaling after the MN 701 before movement, and in this case, the reservation state on the SANE 707 is switched from level Q2 to level Q1. During the switching of the reservation state, the SANE 707 should issue a message to the group server 725 so as to delete the registration. This can be implemented by transmitting a group join request message 3007 with “group join token” setting at an error value to the group server 725.

### Embodiment 4

Embodiment 4 prevents the shortage of space for a group identifier by optimizing group management so as to enable the application to larger network environment. This can be implemented by sharing a group among different sessions from the same MN 101 before movement. For instance, the group may be multiplexed using a source address so as to be a multiplexed multicast group with a specific sender. In order to support this, information on the source address has to be added to a data entry (Srv_Group) in the group server 201. Further, “group information” should include sender information. In this case, corresponding SANEs join in a group using a specific source address. When a message is to be transmitted to the group server 201, the MN 101 describes sender information on the message or uses a wild card as the sender information so that the group server 201 can transmit to the corresponding SANEs.

### Embodiment 5

In Embodiment 5, when the group server 201 needs to transmit a message in a method depending on a unicast address, the group server 201 can execute a NAT traverse (or NAT traversal) function. For instance, a group server 201 executes a function of a STUN server of Non-Patent Document 1 to notify a SANE in a NAT domain of a public address allocated by a NAT. When the group server 201 itself is located in the NAT domain 100, a function of a stun server is used to obtain a public address used for the transmission of a group registration confirmation message 3003 to the MN 101.

### Embodiment 6

In the above-stated Embodiments 1 to 5, all SANEs 103 that establish the old path(s) of the MN 101 before movement transmit a group join (Group_Join) request message 3007 to the group server 201, and the group server 201 transmits a group trigger (Group_Trigger) message 3013 to all of SANEs 103, thus increasing the number of messages. Thus, in Embodiments 6 to 9 described below, one SANE of each of the inside and the outside of an address domain as a representative node transmits a group join (Group_Join) request message to a group server, and the group server transmits a group trigger (Group_Trigger) message to such SANEs only. Further, each SANE as the representative node that receives the group trigger (Group_Trigger) message transmits a tear message to other nodes inside and outside of the address domain.

FIG. 17 illustrates a network configuration of Embodiment 6 (or Embodiment 7, 8, 9). A communication session between a MN 801 before movement and CN 811 is established via a link 831, a SANE 803, a link 833, a SANE 805, a link 835, a NAT 807, a link 837, a SANE 809, and a link 839. Then, among these nodes, the MN 801, the SANE 803, and the SANE 805 are located inside of an address domain 800, i.e., on the private address side of the NAT 807, and the SANE 809 and the CN 811 are located outside of the address domain 800, i.e., on the public side of the NAT 807. Further, all of the nodes (MN 801, SANE 803, SANE 805, SANE 809, and CN 811) have connections with a group server 821 via the network 830. Herein, it would be obvious for those skilled in the art that a connection with the group server 821 may be different from FIG. 17, which does not limit the present invention.

Next, let that at a certain time the MN 801 moves to a location (MN 823 of the drawing) outside of the address domain 800. In order to send a signaling message to all of the SANEs 803, 805, and 809 and the CN 811 to tear down (or revoke) the path(s) of the MN 801 before movement that has been established in the domain 800, the MN 823 after movement uses the group server 821 to relay the message.

<Operational Sequence>

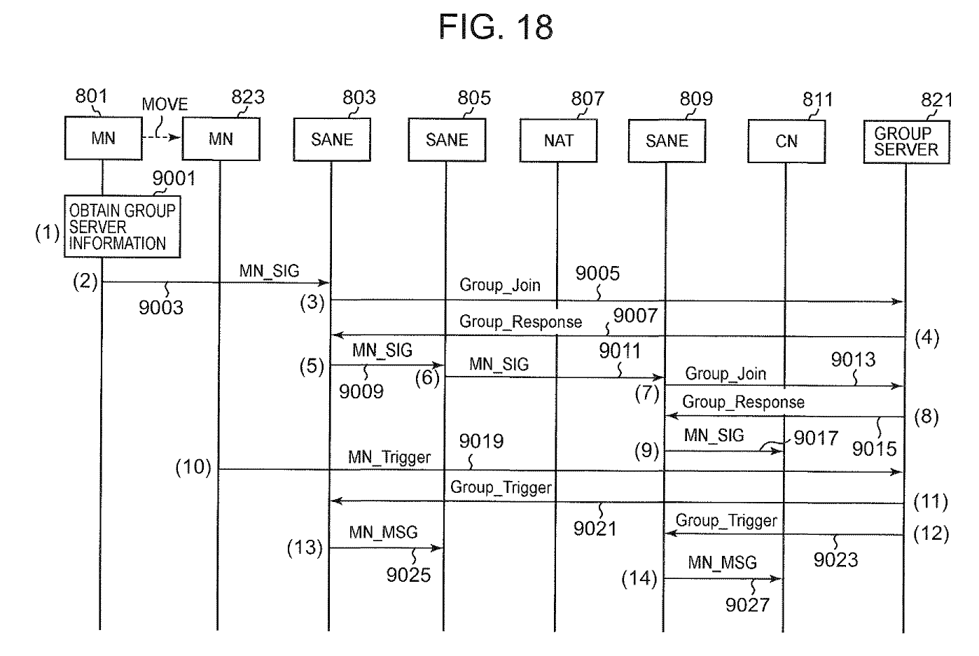

FIG. 18 illustrates an exemplary operational sequence of Embodiment 6. In Embodiment 6, the SANE 803 as the first hop from the MN 801 before movement and the SANE 809 as the first hop from the NAT (NAT server) 807 are representative nodes for group registration.

(1) Firstly, the MN 801 before movement obtains group server information (group information [Group Info] in Embodiment 1]). This group information is obtained by exchanging a group registration (Group_Register) request message 3001 and a group registration confirmation (Group_Confirm) message 3003 in Embodiment 1 (see FIG. 2). As other methods, the MN 801 can obtain group information using a broadcast access control function via a network or an information service of IEEE802.21 function [6].

(2) Next, the MN 801 embeds this obtained group information in a signaling message for session establishment to the CN 811, e.g., in a MN signaling (MN_SIG) message 9003. Herein, the MN signaling (MN_SIG) message 9003 may be a resource reservation message 3105 (FIG. 2) issued by the MN 801 or a resource response message that the CN 811 returns in response to this resource reservation message. The MN signaling (MN_SIG) message 9003 includes a signaling hop-counter. This hop counter is incremented for each SANE through which the MN signaling (MN_SIG) message 9003 passes. For instance, when the MN 801 transmits a MN signaling (MN_SIG) message 9003 with a hop-counter thereof set at “0” and the SANE 803 receives this message 9003, then the hop-counter of the message 9003 is incremented to “1”, which is then set in a MN signaling (MN_SIG) message 9009 to the next SANE 805 for transmission, followed by the hop-counter being similarly incremented for each SANE. Further, the SANE 803 stores this incremented hop-counter value.

(3) Receiving the message 9003, the SANE 803 checks the hop-counter value (=0), so that the SANE 803 recognizes itself as the first hop SANE from the MN 801 and registers the same in the group server 821 indicated by the group information [Group Info]. In FIG. 18, the SANE 803 performs this registration with a group join (Group_Join) request message 9005 transmitted to the group server 821. The group join (Group_Join) request message 9005 is configured with the respective pieces of information (see FIG. 12) described in Embodiment 1, which may include, as an option, message routing information used by the MN signaling (MN_SIG) message 9003, e.g., a flow identifier defined by Non-Patent Document 2, for instance.

(4) Further, as an option, the group server 821 returns a group join response (Group Response) message 9007 to confirm the above registration.

(5) Next, based on the message routing information, the SANE 803 transmits the MN signaling (MN_SIG) message 9009 to the next hop SANE 805. At this time, necessary updating is conducted before transmission, e.g., incrementing the hop-counter value.

(6) The SANE 805 recognizes itself as not being the first hop node by the hop-counter value (=1) in the message 9009, and there is no need to register to the group server 821 in the above (3). Therefore, the SANE 805 performs necessary updating, e.g., to increment the hop-counter value, followed by transmission of a MN signaling (MN_SIG) message 9011 to the next hop SANE 809.

(7) Receiving the message 9011, the SANE 809 detects the existence of the NAT 807. This detection of the NAT 807 can be implemented simply by comparing an IP header in a packet of the message 9011 and the message routing information embedded in the message 9011. For instance, in the case where a source address of the IP header is different from a source address of the message routing information, it indicates that the message 9011 passed through the NAT 807. Note here that, in the case where the message 9011 can be intercepted, the NAT 807 may insert special information indicating the crossing an address border into the message 9011.

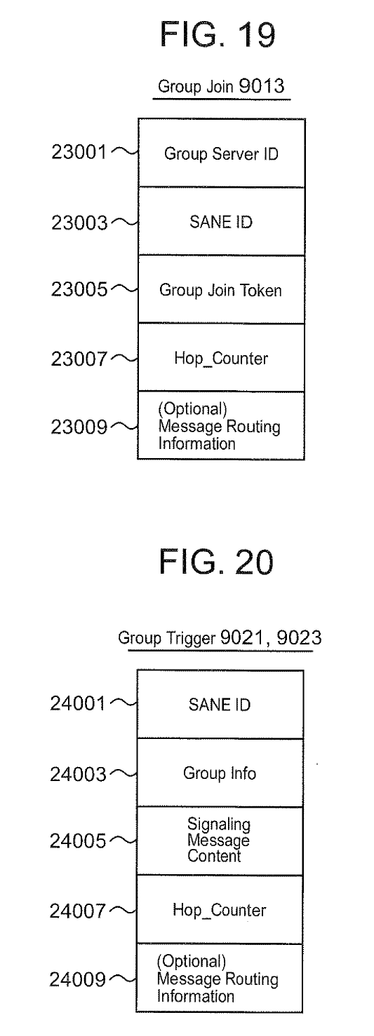

The SANE 809 uses “group information” in the received message 9011 to register to the group server 821. In FIG. 18, the SANE 809 performs this registration with a group join (Group_Join) request message 9013 transmitted to the group server 821. A format of this message 9013 is configured as in FIG. 19 and as follows, for example,

Group_Join:
group server ID 23001 [Group Server ID]
SANE-ID 23003 [SANE ID]
group join token 23005 [Group Join Token]
hop-counter value 23007 [Hop Counter]
   message routing information 23009 [(Optional) Message Routing Information].

That is, this message 9013 includes the hop-counter value 23007 embedded in the received MN signaling (MN_SIG) message 9011 in addition to information in the group join (Group_Join) request message 3007 of Embodiment 1 (FIG. 12). As an option, the SANE 809 may include message routing information 23009 in the message 9013 when it operates in a stateless mode.

(8) The group server 821 returns, as an option, a group join response (Group Response) message 9015 that confirms the above registration.

(9) The SANE 809 transmits a MN signaling (MN_SIG) message 9017 to the CN 811. At this time, before transmission, necessary updating in the message 9017 is performed. This updating includes incrementing of the hop-counter value 23007 and matching the message routing information 23009 with a new address. The CN 811 terminates the received message 9017.

(10) When the MN 801 moves to the new location (MN 823), the MN 823 transmits a MN trigger (MN_Trigger) message 9019 to the group server 821 to signal to the SANEs on the original path(s). This message 9019 includes the same contents as those of the MN trigger (MN_Trigger) message 3011 in Embodiment 1.

(11) (12) Receiving the MN trigger (MN_Trigger) message 9019, the group server 821 checks the SANE that the group server 821 registers. In this example, the SANEs 803 and 809 are registered. The group server 821 converts the received message 9019 into group trigger (Group_Trigger) messages 9021 and 9023, and transmits the same to the registered SANE 803 and 809, respectively. A format of these messages 9021 and 9023 is configured as in FIG. 20 and as follows, for example,

Group_Trigger:
SANE-ID 24001 [SANE ID]
group information 24003 [Group Info]
signaling message contents 24005 [Signaling Message Content]
hop-counter 24007 [Hop Counter]
   message routing information 24009 [(Optional) Message Routing Information].

That is, these messages 9021 and 9023 include the hop-counter value 24007 transmitted from the SANE 809 in addition to information (FIG. 14) included in the group trigger (Group_Trigger) message 3013 in Embodiment 1. Further, in the case where the SANEs 803 and 809 have included message routing information 23009 in the group join (Group_Join) request messages 9005 and 9013, the message routing information 24009 has to be included as well as the hop-counter value 24007 in the group trigger (Group_Trigger) messages 9021 and 9023.

(13) (14) Receiving the messages 9021 and 9023, respectively, the SANEs 803 and 809 extract the signaling message contents 24005 from the messages 9021 and 9023. Then, the SANEs 803 and 809 tear down the state of the old path(s) of the MN 101 established before movement, and executes processing to release the resource thereof. Further, the SANEs 803 and 809 make the SANE 805 and the CN 811, respectively, tear down the state of the old path(s) of the MN 101 established before movement, and further uses the stored message routing information to transmit MN messages (MN_MSG) 9025 and 9027, e.g. as on-path signaling message, in the direction of the CN 811, thus releasing the resource thereof.

Moreover, when transmitting the MN messages (MN_MSG) 9025 and 9027, the SANEs 803 and 809 compare the stored hop-counter value with the hop counter values 24007 in the received group trigger (Group_Trigger) messages 9021 and 9023. Herein, since the hop-counter value 24007 in the received message 9021 is larger, the SANE 803 sets a hop limit number within a transfer range of the message 9025 for transmission of the MN message (MN_MSG) 9025. This hop limit number is calculated by a difference between the received hop counter value and the stored hop counter value. For instance, in the case where the received hop counter value 24007 is 3 and the stored hop counter value is 1, then the hop limit number=2 is set, so that the MN message (MN_MSG) 9025 finishes in two hops.

As another method, the SANE 803 simply embeds the hop-counter value 24007 in the received group trigger (Group_Trigger) message 9021 in the MN message (MN_MSG) 9025 as a “hop-counter limit number”, and sets the hop-counter value in the MN message (MN_MSG) 9025 to the stored hop-counter value. Then, the SANE 805 updates the hop-counter value in the received MN message (MN_MSG) 9025, and if the updated value is equal to the “hop-counter limit number”, the SANE 805 stops the transfer of the MN message (MN_MSG) 9025 to upstream. Herein, it would be obvious for those skilled in the art that other methods can be used to decide the hop limit number of the MN message (MN_MSG) 9025, which does not limit the present invention.

Receiving the group trigger (Group_Trigger) message 9023 from the group server 821, if the received hop-counter value 24007 is smaller than the stored hop-counter value, there is no need for the SANE 809 to process the hop limit number of the MN message (MN_MSG) 9027, and this message 9027 is terminated by the CN 811.

Herein, in the case of stateless SANEs, i.e., in the case where any signaling state is not kept, the SANEs 803 and 809 have to make the group join (Group_Join) request messages 9005 and 9013 include identifiers of the SANEs 803 and 809 and their message routing information 23009. This information 23009 is included when the group server 821 transmits the group trigger (Group_Trigger) messages 9021 and 9023. Receiving the group trigger (Group_Trigger) message 9021 and 9023, the SANEs 803 and 809 check the identifiers and use the message routing information to configure the MN messages (MN_MSG) 9025 and 9027. The identifiers of the SANE 803 and 809 may be identifiable unique values, e.g., an MAC address or a sufficient large random value.

### Embodiment 7

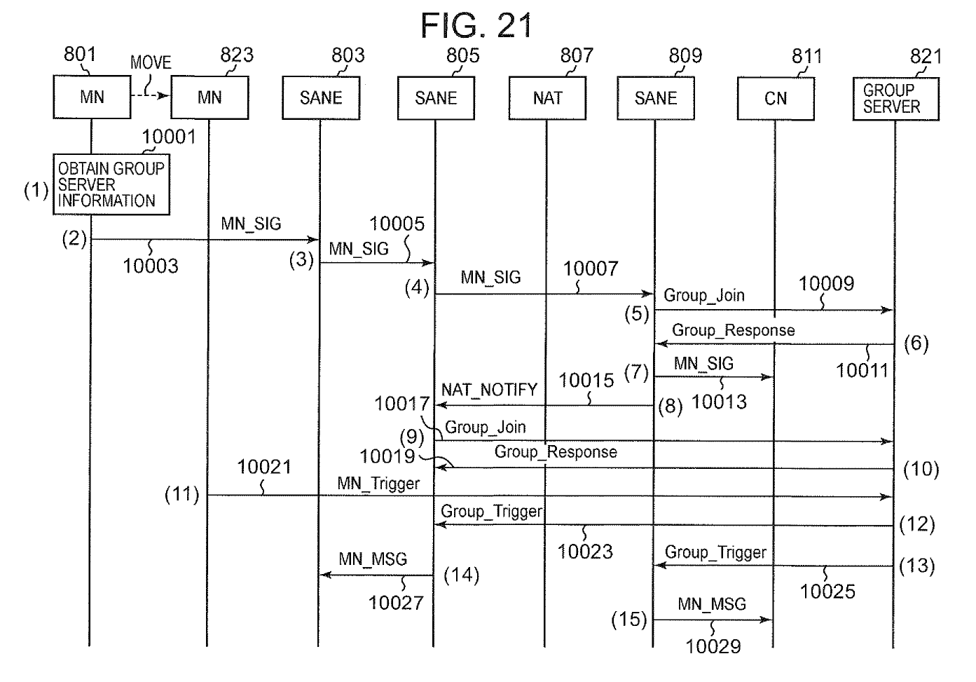

FIG. 21 illustrates, as Embodiment 7, another exemplary operational sequence in the network configuration of FIG. 17. In Embodiment 7, SANEs 809 and 805 as first hops from a NAT (NAT server) 807 serve as representative nodes to perform group registration.

(1) Firstly, a MN 801 at a location before movement obtains group server information (group information [Group Info] of Embodiment 1) similarly to FIG. 18(1).

(2) Next, the MN 801 embeds this obtained group information in a signaling message for session establishment with respect to the CN 811, e.g., in a MN signaling (MN_SIG) message 10003. Herein, this MN signaling (MN_SIG) message 10003 is similar to the message 9003 of FIG. 18(2), where the hop counter is not necessary.

(3) Receiving this message 10003, the SANE 803 executes normal response processing to perform necessary updating, and thereafter transfers a MN signaling (MN_SIG) message 10005 to the next hop SANE 805. If this message 10005 is a resource reservation message, the SANE 803 allocates a required resource to the session of this reservation message.

(4) The same processing is conducted with respect to the SANE 805 also, and a MN signaling (MN_SIG) message 10007 is transmitted to the SANE 809 via the NAT 807.

(5) Receiving this message 10007, the SANE 809 is informed of the existence of the NAT 807. This can be implemented by checking the IP header of the received packet and the message routing information embedded in the message 10007. For instance, in the case where this IP header and the message routing information show different source addresses, this means that a NAT exists between the SANE 809 and the SANE 805 as the previous hop. Thereby, the hop 809 transmits a group join (Group_Join) request message 10009 to the group server 821, thus conducting group registration.

(6) The SANE 809 receives, from the group server 821, a group join response (Group Response) request message 10011 as an option.

The group response (Group_Join) request message 10009 and the group join response (Group Response) message 10011 may have the same configuration as that in Embodiment 1 (FIGS. 12 and 13). However, if the SANE 809 is stateless, the group join (Group Response) request message 10009 may further include a SANE identifier, a NAT outside flag, and updated message routing information. This special information is stored in the group server 821.

(7) Next, the SANE 809 performs necessary updating, e.g., adaptation of the message routing information, and thereafter transmits a MN signaling (MN_SIG) message 10013 to the CN 811. This message 10013 is terminated by the CN 811.

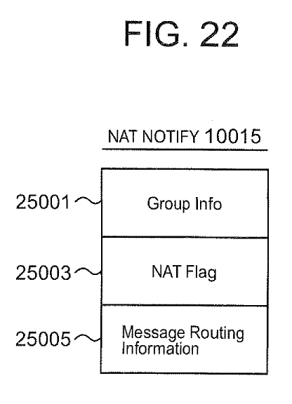

(8) The SANE 809 further returns a NAT notification (NAT_NOTIFY) message 10015 to the SANE 805. This message 10015 is a message to notify the SANE 805 of the existence of a NAT between the SANE 805 and the SANE 809, and a format thereof is illustrated in FIG. 22 and as follows,

NAT_NOTIFY:
group information 25001 [Group Info]
NAT flag 25003 [NAT Flag]
message routing information 25005 [Message Routing Information].

The group information 25001 is the same as that of Embodiment 1. The NAT flag 25003 shows the existence of the NAT 809, and the message routing information 25005 is an option in the case where the SANE 805 operates in a stateless manner. The message routing information 25005 is information used in the NAT domain 800, i.e., information of the MN signaling (MN_SIG) message 10007 received from the SANE 805.

(9) (10) Receiving the NAT notification (NAT_NOTIFY) message 10015, the SANE 805 registers to the group server 821 shown by the group information 25001. Similarly to Embodiment 1, this registration is performed with the group join (Group_Join) request message 10017 and the group join response (Group Response) message 10019. If the SANE 805 operates in a stateless manner, the group join (Group_Join) request message 10017 includes a SANE identifier, a NAT inside flag, and message routing information.

(11) When the MN 801 moves to a new location (MN 823), the MN 823 transmits a MN trigger (MN_Trigger) message 10021 to the group server 821 to signals to the SANEs on the original path(s). This message 10021 includes the same contents as those of the MN trigger (MN_Trigger) message 3011 in Embodiment 1.

(12) (13) Receiving the MN trigger (MN_Trigger) message 10021, the group server 821 converts the received message 10021 into group trigger (Group_Trigger) messages 10023 and 10025, and transmits the same to the registered SANE 805 and 809, respectively. A format of these messages 10023 and 10025 is the same as that of Embodiment 1, where they may include a SANE identifier, a NAT inside flag or a NAT outside flag, and message routing information as an option.

(14) (15) Receiving the group trigger (Group_Trigger) messages 10023 and 10025, respectively, the SANEs 805 and 809 convert the messages 10023 and 10025 into MN messages (MN_MSG) 10027 and 10029, respectively, e.g. as on-path signaling messages, similarly to Embodiment 6. Then, the SANE 805 as a node in the NAT domain 800 transfers this message 10027 in the direction of the MN 801 before movement, and the SANE 809 as a node outside of the NAT domain 800 transfers this message 10029 in the direction of the CN 811. At this time, the SANEs 805 and 809 decide the transfer directions of the messages 10027 and 10029 based on the stored signaling status.

In the case where the SANEs 805 and 809 operate in a stateless mode, the SANEs 805 and 809 let the group join (Group_Join) request messages 10017 and 10009 include necessary information, e.g., a NAT inside flag or a NAT outside flag, message routing information, a SANE identifier and the like. The group server 821 makes the group trigger (Group_Trigger) messages 10023 and 10025 include this information. Thus, receiving these messages 10023 and 10025, respectively, the SANEs 805 and 809 in a stateless mode create message routing information to route the MN messages (MN_MSG) 10027 and 10029 using this information. This operation allows the MN messages (MN_MSG) 10027 and 10029 to terminate naturally, and therefore there is no need to provide a hop limit number.

### Embodiment 8

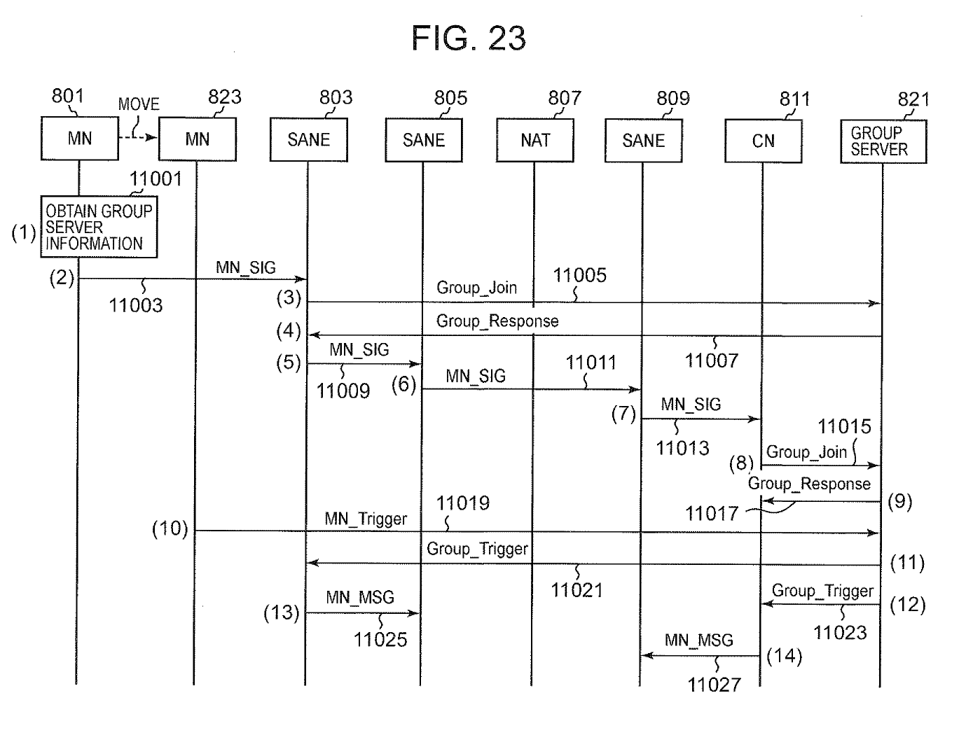

FIG. 23 illustrates, as Embodiment 8, an exemplary operational sequence that is a modification example of Embodiments 6 and 7. In Embodiment 8, the first hop SANE 803 from the MN 801 before movement serves as a representative node and the CN 811 (or SANE 809) serves as a representative node outside of a domain 800.

(1) Firstly, the MN 801 before movement obtains group server information (group information [Group Info] of Embodiment 1) similarly to FIG. 18 and FIG. 21(1).

(2) Next, the MN 801 transmits this obtained group information, e.g., in a MN signaling (MN_SIG) message 11003, to the CN 811. Herein, this MN signaling (MN_SIG) message 11003 includes the following information embedded therein as well as the hop-counter of Embodiment 6:
a NAT flag indicating whether a NAT is detected or not,
an inside flag indicating whether the SANEs 803 and 805 in the NAT domain 800 register to the group server 821 or not, and/or
an outside flag indicating whether the SANE 809 outside of the NAT domain 800 registers to the group server 821 or not.

Herein, the MN 801 may include, in the message 11003, a policy indicating a judgment criterion as to which SANEs are to register to the group server 821. When transmitting the message 11003, the MN 801 resets these NAT flag, inside flag and outside flag. In this case, a SANE that receives the message 11003 can decide as to whether the SANE itself registers or not to the group server 821 based on its own local information and the above policy in the message 11003. In the case where the NAT flag, the inside flag and the outside flat are not set, the SANE registers itself to the group server 821 when its own local information and the above policy permit. Further, in the case where the inside flag and the NAT flag are set but the outside flag is not set, the SANE registers itself to the group server 821. The other SANES cannot register themselves to the group server 821.

(3) For instance, as for the SANE 803, since none of the above-described three flags in the message 11003 are set, the SANE 803 decides to register itself to the group server 821 when its own local information and the above-stated policy permit. Then, the SANE 803 deciding the registration transmits a group join (Group_Join) request message 11005 to the group server 821.

(4) Next, the SANE 803 receives, from the group server 821, a group join response (Group Response) message 11007 as an option. The request message 11005 and the response message 11007 are similar to those in Embodiments 6 and 7.

(5) Next, the SANE 803 performs necessary updating, and thereafter transfers a MN signaling (MN_SIG) message 11009 to the SANE 805 as the next hop. This updating includes setting the inside flag because the SANE 803 registers to the group server 821.

(6) After performing necessary updating, the SANE 805 transfers a MN signaling (MN_SIG) message 11011 to the next hop. Herein, since the inside flag in the message 11009 from the SANE 803 is set, the SANE 805 does not register to the group server 821.

(7) Receiving the message 11011 from the SANE 805, the SANE 809 detects the existence of the NAT 807 similarly to Embodiments 6 and 7. Thereby, the SANE 809 sets a NAT flag in a MN signaling (MN_SIG) message 11013 transferred to the next hop. Further, the SANE 809 inserts, as a NAT counter, a hop-counter value in the message 11011 received from the SANE 805 into the message 11013 transferred to the next hop. Herein, the SANE 809 can register to the group server 821 when its own local condition and the policy in the message 11011 received from the SANE 805 permit. In this example, however, since the policy shows that “CN 811 registers”, the SANE 809 does not register.

(8) Receiving the message 11013 from the SANE 809, the CN 811 is informed that the NAT Flag and the inside flag in the message 11013 are set but the outside flag is not set, and the CN 811 decides to register to the group server 821. The CN 811 performs this registration by transmitting a group join (Group_Join) request message 11015 to the group server 821. The CN 811 makes the request message 11015 include a NAT counter. The CN 811 further increments the hop-counter value and stores the same.

(9) Next, the CN 811 receives a group join response (Group Response) message 11017 as an option from the group server 821. The request message 11015 and the response message 11017 are similar to those in Embodiments 6 and 7.

(10) When the MN 801 moves to a new location (MN 823), the MN 823 transmits a MN trigger (MN_Trigger) message 11019 to the group server 821 to signal to the SANEs on the original path(s) similarly to Embodiments 6 and 7.

(11) (12) The group server 821 converts the received message 11019 into group trigger (Group_Trigger) messages 11021 and 11023, and transmits the same to the registered SANE 803 and 811, respectively. These messages 11021 and 11023 include a NAT counter as well as the same information as in Embodiments 6 and 7.

(13) Receiving the group trigger (Group_Trigger) messages 11021, the SANE 803 converts this message 11021 into a MN message (MN_MSG) 11025 similarly to Embodiments 6 and 7. In this case, however, the SANE 803 transmits this MN message (MN_MSG) 11025 in both of the direction of the CN 811 and the direction of the original location of the MN 801. Since the SANE 803 is located in the NAT domain 800, the SANE 803 performs hop limit to the message 11025 in the direction of the CN 811 similarly to Embodiment 6. This calculation of the hop limit number is conducted based on the NAT counter in the group trigger (Group_Trigger) message 11021.

(14) Receiving the group trigger (Group_Trigger) message 11023, since the CN 811 is located outside of the NAT domain 800, the CN 811 converts this message 11023 into a MN message (MN_MSG) 11027 and transmits the same in the direction of the original location of the MN 801. When transmitting this message 11027, the CN 811 applies hop limit. This calculation of the hop limit number is conducted based on the NAT counter in the group trigger (Group_Trigger) message 11023 and the stored hop-counter value. For instance, the hop limit number in the MN message (MN_MSG) 11027 is calculated by hop-counter value NAT counter 1.

Each SANE receiving this MN message (MN_MSG) 11027, e.g., the SANE 809, decrements this hop limit number, sets this updated hop limit number in the MN message to the next hop, and transfers this MN message in the direction of the original location of the MN 801. When the SANE 809 is informed that the hop limit number after decrementing is 0, the SANE 809 does not transmit a MN message to the next hop node.

Herein, it would be obvious for those skilled in the art that a SANE registered outside of the NAT domain 800 may be one other than the CN 811. If the SANE 809 is registered, when receiving the group trigger (Group_Trigger) message 11023, the SANE 809 converts this message 11023 into a MN message (MN_MSG) and has to transmit the same also in the direction of the CN 811. Further, the SANE 809 outside of the NAT domain 800 does not have to provide hop limit for the MN message (MN_MSG) transmitted in the direction of the CN 811.

The above-stated Embodiment 8 has an exception. For instance, in the case where none of the SANEs in the NAT domain 800 register to the group server 821, the MN signaling (MN_SIG) message 11003 transmitted from the MN 801 before movement is received by the CN 811 without the inside flag being set. In this case, the CN 811 has to transmit a signaling message in the direction opposite to the same path and instruct which SANE should register. This instruction can be implemented by using a hop-counter value. As another method, the CN 811 can issue an instruction by describing, in the policy, that the first SANE in the direction opposite to the same path in the NAT domain 800 should register.

In the above-stated Embodiment 8, a transfer range of the MN messages (MN_MSG) 11025 and 11027 to tear down a state of the old path(s) of the MN 801 before movement and release a resource thereof is implemented by using a hop-counter value. Herein, in unstable network environment, rerouting occurs during a session, and therefore a hop-counter value changes for each SANE after rerouting. Thus, in the case where the MNs 801 and 823 and the SANEs 803, 805 and 809 decide that the network is unstable, some security measure is required. As an example of the security measure, the MN 801 before movement can issue an instruction using the MN signaling (MN_SIG) message 11003 so as to include that special measure is required for the SANE 803, e.g., to include a “NAT drop flag” when the MN message (MN_MSG) 11025 is created. When the SANE 805 is informed of the “NAT drop flag” in the MN message (MN_MSG) 11025 to detect that the message 11025 arrives at the NAT 807, then the SANE 805 drops the message 11025. As another method, when the NAT 807 itself may intercept the message 11025 and is informed of the “NAT drop flag”, the message 11025 can be dropped.

### Embodiment 9

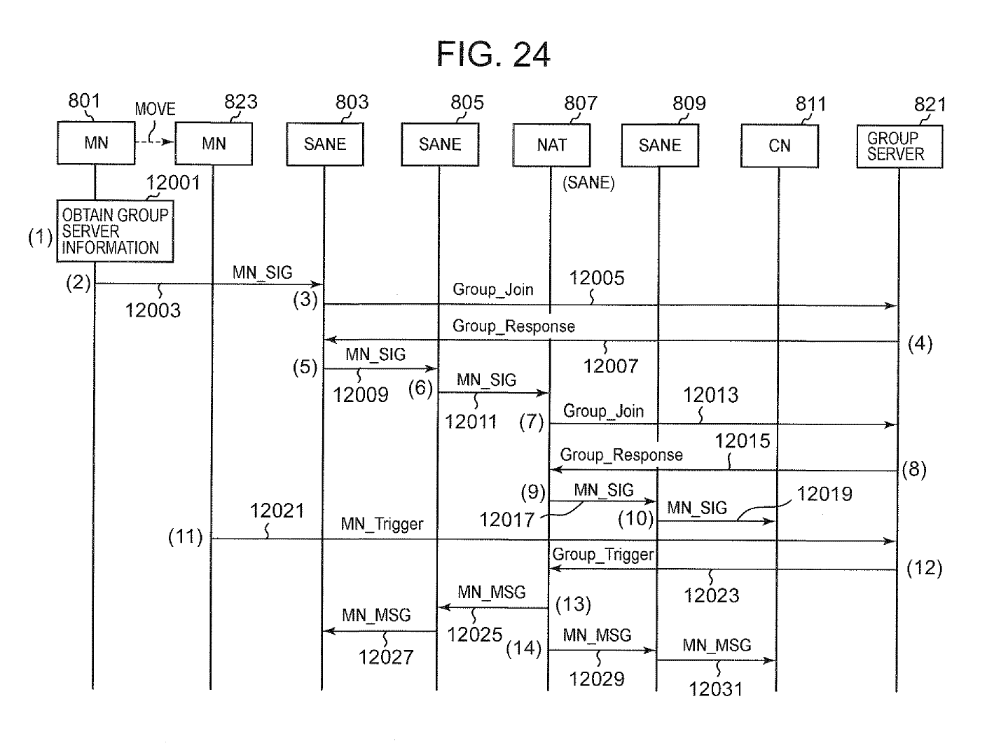

FIG. 24 illustrates an exemplary operational sequence of Embodiment 9. In this embodiment, a NAT 807 itself acts as a SANE and serves as a representative node (note that a SANE 803 registers but is cancelled or revoked). That is, the NAT 807 intercepts all signaling messages for processing. The operation of Embodiment 9 can be applied to any of Embodiments 6, 7, or 8, and therefore the following description omits the duplicated operation. The NAT 807, however, needs to have a special function to process a signaling message.

(1) to (4) Similarly to Embodiments 6, 7, and 8, the SANE 803 in the NAT domain 800 uses a group join (Group_Join) request message 12005 to register to the group server 821. Thereby, an entry is created in the group server 821.

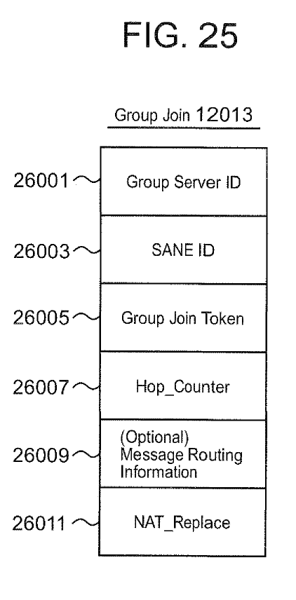

(5) to (8) When a MN signaling (MN_SIG) message 12011 arrives at the NAT 807, the NAT 807 uses a group join (Group_Join) request message 12013 to register to the group server 821. As illustrated in FIG. 25, this request message 12013 includes, as a special flag, a NAT-replace flag 26011 that requests that this registration is replaced with an entry from another SANE on the same path created in the group server 821. Other information 26001, 26003, 26005, 26007, and 26009 in the request message 12013 is the same as in FIG. 19.

(9) (10) Subsequently, after performing necessary processing in Embodiments 6, 7, or 8, the NAT 807 transfers a MN signaling (MN_SIG) message 12017 in the direction of the CN 811. Herein, the NAT 807 uses this message 12017 so that other SANEs do not register to the group server 821. In the case of the application to Embodiment 8, for example, three flags of the NAT flag, the inside flag and the outside flag are set. This operation allows one SANE, i.e., the NAT 807 to register to the group server 821.

(11) (12) Thus, when the MN 801 moves to a new location (MN 823) and the group server 821 receives a MN trigger (MN_Trigger) message 12021 from the MN 823, then the group server 821 transmits a group trigger (Group_Trigger) message 12023 only to the NAT 807.

(13) (14) Receiving this message 12023, the NAT 807 converts (or translates) this message 12023 into MN messages (MN_MSG) 12015 and 12029 similarly to Embodiments 6, 7, and 8. The NAT 807 transmits the message 12025 into the NAT domain 800 in the direction of the MN 801 at the original location, and transmits the message 12029 outside of the NAT domain 800 in the direction of the CN 811. Herein, these two messages 12025 and 12029 are transferred using different message routing information. Since these two messages 12025 and 12029 are naturally stopped by the SANE 803 and the CN 811, respectively, there is no need to provide hop limit.

### Embodiment 10

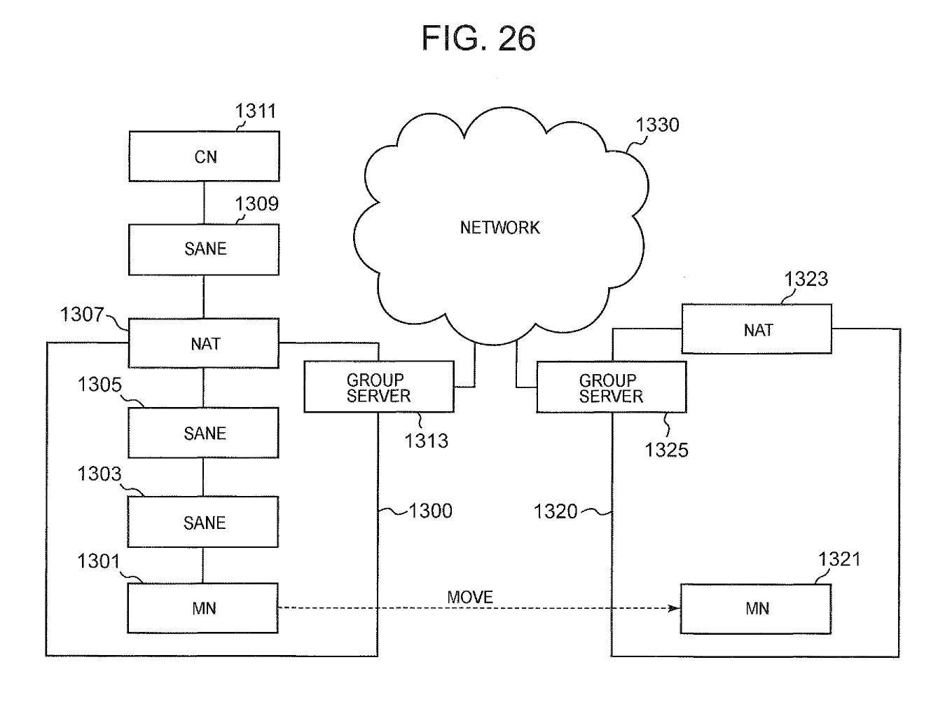

FIG. 26 illustrates a network configuration of Embodiment 10. A group server 1313 is attached to a network (source NAT domain) with which MN 1301 connects. All nodes including SANEs 1301, 1303, and 1305 in the source NAT domain 1300 and a SANE 1309 and a CN 1311 outside of the source NAT domain 1300 access the group server 1313. It would be obvious for those skilled in the art that the group server 1313 does not have to be located physically in the source NAT domain 1300, but may be at a remote location that connects with the source NAT domain 1300. The MN 1301 may have information on the group server 1313 that connects with the source NAT domain 1300 in advance or may be informed by a DNS.

Let that the MN 1301 moves to a new location (MN 1321) and the MN 1321 connects with a new network (destination NAT domain) 1320. A similar group server 1325 connects with the destination NAT domain 1320. The MN 1321 is informed of information on this new group server 1325 by other means. The group server 1325 connects with the group server 1313 via a network 1330.

In the case where Embodiments 6, 7, 8 and 9 are applied to this network configuration, the MN 1321 at the target place transmits a MN trigger (MN_Trigger) message including information on the source group server 1313 to the target group server 1325. Receiving this MN trigger (MN_Trigger) message, the target group server 1325 tries to transfer this message to the source group server 1313 based on the information embedded in this message. Then, when this message arrives at the source group server 1313, Embodiments 6, 7, 8, and 9 can be applied.

The information on the source group server 1313 embedded in the above-stated MN trigger (MN_Trigger) message may include a unique ID of the group server 1313 and an ID of the source NAT domain 1300. It would be obvious for those skilled in the art that the MN trigger (MN_Trigger) message can be transferred from the target group server 1325 to the source group server 1313 via another group server.

The MN 1321 may transmit the MN trigger (MN_Trigger) message to a local target group server 1325 via another means, e.g., by unicasting to an address of the target group server 1325, anycasting or multicasting to the target group server 1325, or using a special link layer method. Example of the special link layer methods is IEEE802.1x uncontrolled part, i.e., an EAP message can be used.

Further, it would be obvious for those skilled in the art that the target group server 1325 does not have to have all functions, which may be a proxy that simply receives a MN trigger (MN_Trigger) message and relays the same. Actual functions of the target group server 1325 may be disposed at any locations, and in an actual network, the group servers 1313 and 1325 may be an AAA (Authentification Authorization and Accounting) agent, a local policy function, or a simple local DNS server, e.g. in the local area network.

Note that the above-stated embodiment is not limited to a NAT, but can be used to the case where other domains exist, including a GGSN (Gateway GPRS Support Node) or PDN (Packet Data Network) Gateway in Non-Patent Document 9, for example.

Note that each functional block used in the descriptions of the above-stated embodiments may be typically implemented as a LSI that is an integrated circuit. These blocks may be individually configured as one chip, or one chip may include a part or all of the functional blocks. LSIs may be called an IC, a system LSI, a super LSI, and an ultra LSI depending on the degree of integration. A technique for integrated circuit is not limited to LSI, but an integrated circuit may be achieved using a dedicated circuit or a general-purpose processor. After manufacturing a LSI, a FPGA (Field Programmable Gate Array) capable of programming and a reconfigurable processor capable of reconfiguring connection and setting of a circuit cell inside a LSI may be used. Further, if a technique for integrated circuit that replaces LSIs becomes available by the development of a semiconductor technique or derived techniques, functional blocks may be naturally integrated using such a technique. For instance, biotechnology may be applied thereto.

### INDUSTRIAL APPLICABILITY

The present invention has an effect of, when a mobile node has moved outside of a domain using a local address, enabling the old path(s) of the mobile node in the domain to be torn down without using special means such as a STUN server, and can be applied to a system that executes NSIS (Next Steps In Signaling) protocol, for example.

1. A communication method wherein, when a mobile node located in a domain using a local address has moved outside of the domain, the mobile node signals to a node in the domain, comprising the steps of:
a group registration step of transmitting, to a representative server, information on a group to which the mobile node and the node belong, the node establishing a state of the mobile node in the domain, to register the same to the representative server;
a step of transmitting the information on the group from the mobile node that has moved outside of the domain to the representative server to notify the representative server of the same;
a signaling step of signaling to the node belonging to the group from the representative server notified of the information on the group; and
a step of modifying the state of the mobile node established with the signaled node in the domain.

2. The communication method according to claim 1, wherein in the signaling step, the information on the group is a multicast address of the mobile node and the node, and the signaling is from the representative server to the multicast address.

3. The communication method according to claim 1, wherein the group registration step comprises the steps of:
a step of notifying, from the mobile node, the node in the domain of the information on the group using a resource reservation message including the information on the group; and
a step of notifying, from the node notified of the information on the group, the representative server of joining to the group using a group join message including the information on the group.

4. A communication system wherein, when a mobile node located in a domain using a local address has moved outside of the domain, the mobile node signals to a node in the domain, the communication system comprising:
group registration means that transmits, to a representative server, a group to which the mobile node and the node belong, the node establishing a state of the mobile node in the domain, to register the same to the representative server;
means that transmits information on the group from the mobile node that has moved outside of the domain to the representative server to notify the representative server of the same;
signaling means that signals to the node belonging to the group from the representative server notified of the information on the group; and
means that modifies the state of the mobile node established with the signaled node in the domain.

5. The communication system according to claim 4,
wherein the information on the group is a multicast address of the mobile node and the node, and
the signaling means signals from the representative server to the multicast address.

6. The communication system according to claim 4,
wherein the group registration means comprises:
means that notifies, from the mobile node, the node in the domain of the information on the group using a resource reservation message including the information on the group; and
means that notifies, from the node notified of the information on the group, the representative server of joining to the group using a group join message including the information on the group.

7. A mobile node in a communication system wherein, when the mobile node located in a domain using a local address has moved outside of the domain, the mobile node signals to a node in the domain, the mobile node comprising;
group registration means that transmits, to a representative server, information on a group to which the mobile node and the node belong, the node establishing a state of the mobile node in the domain, to register the same to the representative server; and
means that, when the mobile node has moved outside of the domain, transmits, to the representative server, information on the group to modify the state of the mobile node established in the domain to notify the representative server of the same.

8. The mobile node according to claim 7, wherein the information on the group is a multicast address of the mobile node and the node, and signaling is from the representative server to the multicast address.

9. The mobile node according to claim 7, wherein the group registration means comprises means that notifies the node in the domain of the information on the group using a resource reservation message including the information on the group; and
the node notified of the information on the group notifies the representative server of joining to the group using a group join message including the information on the group.

10. A representative server in a communication system wherein, when a mobile node located in a domain using a local address has moved outside of the domain, the mobile node signals to a node in the domain, the representative server comprising:
group registration means that, when information on a group to which the mobile node and the node establishing a state of the mobile node in the domain belong is transmitted to the representative server, registers the information on the group; and
signaling means that, when the mobile node that has moved outside of the domain transmits the information on the group to the representative server to notify the representative server of the same, transmits signaling to the node belonging to the group so that the state of the mobile node established in the domain is modified.

11. The representative server according to claim 10,
wherein the information on the group is a multicast address of the mobile node and the node, and
the signaling means signals to the multicast address.

12. The representative server according to claim 10, wherein when the mobile node notifies the node in the domain of the information on the group using a resource reservation message including the information on the group; and when the node notified of the information on the group notifies the representative server of joining to the group using a group join message including the information on the group, the group registration means registers the information on the group.

13. A node in a communication system wherein, when a mobile node located in a domain using a local address has moved outside of the domain, the mobile node signals to the node in the domain, the node comprising:
group registration means that transmits, to a representative server, information on a group to which the mobile node and the node belong, the node establishing a state of the mobile node in the domain, to register the same to the representative server; and
means that, when the mobile node that has moved outside of the domain transmits the information on the group to the representative server and when the representative server notified of the information on the group signals the node belonging to the group, modified the state of the mobile node established in the domain.

14. The node according to claim 13, wherein the information on the group is a multicast address of the mobile node and the node.

15. The node according to claim 13, wherein when the mobile node notifies the node in the domain of the information on the group using a resource reservation message including the information on the group, the group registration means notifies the representative server of joining to the group using a group join message including the information on the group.

16. The communication method according to claim 1,
wherein
in the group registration step, a first representative node and a second representative node register the information on the group to the representative server, the first representative node being one of a plurality of nodes establishing a state of the mobile node in the domain and the second representative node being one of a plurality of nodes establishing a state of the mobile node outside of the domain,
in the signaling step, signaling is from the representative server only to the first and the second representative nodes, and
each of the first and the second representative nodes signals to other nodes that established a state of the mobile node in the domain and outside of the domain to modify the state of the mobile node.

17. The communication system according to claim 4,
wherein
the group registration means making a first representative node and a second representative node register the information on the group to the representative server, the first representative node being one of a plurality of nodes establishing a state of the mobile node in the domain and a second representative node being one of a plurality of nodes establishing a state of the mobile node outside of the domain,
the signaling step means signals from the representative server only to the first and the second representative nodes, and
each of the first and the second representative nodes signals to other nodes that has established a state of the mobile node in the domain and outside of the domain to modify the state of the mobile node.

18. The representative server according to claim 10,
wherein
when a first representative node and a second representative node transmit the information on the group to the representative server, the first representative node being one of a plurality of nodes establishing a state of the mobile node in the domain and a second representative node being one of a plurality of nodes establishing a state of the mobile node outside of the domain, the group registration means registers the information on the group, and
when the mobile node that has moved outside of the domain transmits the information on the group to the representative server to notify the representative server of the same, the signaling means signals only to the first and the second representative nodes, and each of the first and the second representative nodes signals to other nodes that has established a state of the mobile node in the domain and outside of the domain to modify the state of the mobile node.

19. The node according to claim 13,
wherein
the group registration means registers the information on the group to the representative server while setting a first representative node and a second representative node, the first representative node being one of a plurality of nodes establishing a state of the mobile node in the domain and a second representative node being one of a plurality of nodes establishing a state of the mobile node outside of the domain,
the node further comprising means that modifies a state of the mobile node as the first or the second representative node, or as another node that has established states of the mobile node in the domain and outside of the domain, when signaling from the representative server is only to the first and the second representative nodes.

20. The node according to claim 19,
wherein the first representative node is a node that is the closest to the mobile node.

21. The node according to claim 19,
wherein the first representative node is a node that is the closet to a network address translator provided at an edge of the domain.

22. The node according to claim 19,
wherein the second representative node is a node that is the closet to a network address translator provided at an edge of the domain.

23. The node according to claim 19,
wherein the second representative node is a correspondent node of the mobile node.

24. The node according to claim 19,
wherein the first and the second representative nodes are a network address translator provided at an edge of the domain.
